(19) United States
(12) Patent Application Publication
(10) Pub. No.: US 2026/0205922 A1
(43) Pub. Date: Jul. 16, 2026

(54) CHANNEL AND FRAME STRUCTURES FOR ZERO-POWER PASSIVE DEVICES

(71) Applicant: QUALCOMM Incorporated, San Diego, CA (US)

(72) Inventors: Linhai HE, San Diego, CA (US); Yuchul KIM, San Diego, CA (US); Zhikun WU, Beijing (CN); Ahmed ELSHAFIE, San Diego, CA (US); Gavin Bernard HORN, La Jolla, CA (US); Francesco PICA, San DIego, CA (US); Peter GAAL, San Diego, CA (US)

(21) Appl. No.: 19/128,945

(22) PCT Filed: Dec. 20, 2022
(86) PCT No.: PCT/CN2022/140235

§ 371 Date: May 9, 2025

(51) Int. Cl. H04W 48/16

(52) U.S. Cl. CPC H04W 48/16

(57) ABSTRACT

Methods, systems, and devices for wireless communications are described. The techniques described herein disclose identifying passive devices using a network of reader devices, as well as enabling reader devices to configure passive devices with a communication frame structures to facilitate wireless communication between the reader devices and the passive devices to provide more efficient utilization of communication resources. A first reader device receives from a second reader device, a message including data to be communicated to a passive device and transmits a continuous wave signal. The first reader receives a backscattered response message from the passive device. The first reader transmits the data to the passive device based on the backscattered response.

### CROSS REFERENCE

This application is a 371 National Stage of PCT Application No. PCT/CN2022/140235, filed on Dec. 20, 2022, entitled “CHANNEL AND FRAME STRUCTURES FOR ZERO-POWER PASSIVE DEVICES”, and assigned to the assignee hereof. The disclosure of the prior Application is considered part of and is incorporated by reference into this Patent Application.

### FIELD OF TECHNOLOGY

The present disclosure relates to wireless communications, including channel and frame structures for zero-power passive devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may include passive devices, such as radio frequency identifier (RFID) tags, to perform certain operations such as location tracking and identification. Passive devices may not have their own power sources, but may receive power from continuous wave signals transmitted by reader devices. For example, a reader device may transmit a continuous wave signal to a passive device, where the passive device uses energy from the continuous wave signal to activate radio frequency components and “backscatter” the continuous wave signal back to the reader device.

### SUMMARY

The described techniques relate to improved methods, systems, devices, and apparatuses that support channel and frame structures for passive devices. For example, the described techniques provide for locating passive devices using a network of reader devices, as well as enabling reader devices to configure passive devices with communication frame structures that are used for wireless communication between the reader devices and the passive devices. For example, upon identifying data to be sent to a passive device, a network node (e.g., a home reader) device may identify a current or last-known reader device associated with the passive device by referencing a table or other data object that maps passive devices to “last-known” reader devices within the network of reader devices. Subsequently, the current or last-known reader device may attempt to relay the data to the reader device, and may relay the data to surrounding reader devices if the reader device is unable to locate the passive device. In cases where the passive device is associated with a new reader device, the respective devices may inform the network node or home reader to update the table accordingly.

Upon identifying a passive device, a reader device may transmit a continuous wave signal that is configured to activate radio frequency circuitry at a passive device. The reader device may subsequently modulate a control message (e.g., master information block (MIB), system information block (SIB)) on top of the continuous wave signal. The control message may indicate a communication frame structure including resources usable for time-domain multiplexed communications between the respective devices on the same channel that was used to communicate the continuous wave signal and control message. The communication frame structure may include resources for random access channel (RACH) communications, scheduling requests (SRs) from the passive device, resources for exchange of transport blocks (TBs) (e.g., uplink/downlink messages), and the like. As such, the communication frame structure may enable the devices to identify which time-domain resources should be used for various types of signaling. In some cases, the passive device may be configured with a SR message or sequence that the passive device is to use when transmitting SRs so that the reader device knows which passive device is requesting to be scheduled.

A method for wireless communication at a first reader device is described. The method may include receiving, from a second reader device, a message including data to be communicated to a passive device, the passive device in communication with a network of reader devices including the first reader device and the second reader device, transmitting one or more continuous wave signals including discovery messages and an identifier associated with the passive device, receiving a backscattered response message from the passive device based on transmitting the one or more continuous wave signals, and transmitting the data to the passive device based on receiving the backscattered response message.

An apparatus for wireless communication at a first reader device is described. The apparatus may include a processor, memory coupled with the processor, and instructions stored in the memory. The instructions may be executable by the processor to cause the apparatus to receive, from a second reader device, a message including data to be communicated to a passive device, the passive device in communication with a network of reader devices including the first reader device and the second reader device, transmit one or more continuous wave signals including discovery messages and an identifier associated with the passive device, receive a backscattered response message from the passive device based on transmitting the one or more continuous wave signals, and transmit the data to the passive device based on receiving the backscattered response message.

Another apparatus for wireless communication at a first reader device is described. The apparatus may include means for receiving, from a second reader device, a message including data to be communicated to a passive device, the passive device in communication with a network of reader devices including the first reader device and the second reader device, means for transmitting one or more continuous wave signals including discovery messages and an identifier associated with the passive device, means for receiving a backscattered response message from the passive device based on transmitting the one or more continuous wave signals, and means for transmitting the data to the passive device based on receiving the backscattered response message.

A non-transitory computer-readable medium storing code for wireless communication at a first reader device is described. The code may include instructions executable by a processor to receive, from a second reader device, a message including data to be communicated to a passive device, the passive device in communication with a network of reader devices including the first reader device and the second reader device, transmit one or more continuous wave signals including discovery messages and an identifier associated with the passive device, receive a backscattered response message from the passive device based on transmitting the one or more continuous wave signals, and transmit the data to the passive device based on receiving the backscattered response message.

Some examples of the method, apparatuses, and non-transitory computer-readable medium described herein may further include operations, features, means, or instructions for transmitting, to a network entity based on transmitting the data to the passive device, a message indicating the first reader device as a current serving reader device associated with the passive device.

In some examples of the method, apparatuses, and non-transitory computer-readable medium described herein, the message further indicates a first cell that was previously associated with the passive device during prior communications between the passive device and the second reader device.

In some examples of the method, apparatuses, and non-transitory computer-readable medium described herein, the one or more continuous wave signals may be transmitted within one or more additional cells different from the first cell.

In some examples of the method, apparatuses, and non-transitory computer-readable medium described herein, the one or more continuous wave signals may be transmitted via a frequency channel and the method, apparatuses, and non-transitory computer-readable medium may include further operations, features, means, or instructions for transmitting, to the passive device via the one or more continuous wave signals and based on activating radio frequency circuitry of the passive device using the one or more continuous wave signals, a control message indicating a communication frame structure including resources usable for time-domain multiplexed communications between the passive device and the first reader device via the frequency channel and communicating one or more messages with the passive device in accordance with the communication frame structure, where at least one message of the one or more messages includes the data, where the one or more messages may be modulated by the first reader device via the one or more continuous wave signals or backscattered by the passive device based on the one or more continuous wave signals.

Some examples of the method, apparatuses, and non-transitory computer-readable medium described herein may further include operations, features, means, or instructions for transmitting, via the control message, a device identifier associated with the passive device, a set of passive devices including the passive device, or both, where communicating the one or more messages in accordance with the communication frame structure may be based on receiving the device identifier.

In some examples of the method, apparatuses, and non-transitory computer-readable medium described herein, the communication frame structure includes a set of resources usable for receiving scheduling requests and the method, apparatuses, and non-transitory computer-readable medium may include further operations, features, means, or instructions for receiving a scheduling request from the passive device via the set of resources, the scheduling request including an indication of uplink data to be communicated from the passive device to the first reader device, where communicating the one or more messages includes receiving the one or more messages including the uplink data.

Some examples of the method, apparatuses, and non-transitory computer-readable medium described herein may further include operations, features, means, or instructions for transmitting, to the passive device based on the scheduling request, scheduling information for communicating the uplink data, where the one or more messages may be received in accordance with the scheduling information.

Some examples of the method, apparatuses, and non-transitory computer-readable medium described herein may further include operations, features, means, or instructions for transmitting, via the control message, an additional control message, or both, an indication of a scheduling request message indicating a quantity of uplink data to be transmitted by the passive device.

Some examples of the method, apparatuses, and non-transitory computer-readable medium described herein may further include operations, features, means, or instructions for transmitting, via the control message, an indication of one or more trigger conditions for transmitting uplink data to the first reader device, where receiving the one or more messages including the uplink data may be based on data collected by one or more sensors of the passive device satisfying the one or more trigger conditions.

Some examples of the method, apparatuses, and non-transitory computer-readable medium described herein may further include operations, features, means, or instructions for transmitting, via the control message, an indication of a scheduling cycle periodicity associated with the communication frame structure, where communicating the one or more messages in accordance with the communication frame structure may be based on the scheduling cycle periodicity.

In some examples of the method, apparatuses, and non-transitory computer-readable medium described herein, the control message includes a MIB message and the method, apparatuses, and non-transitory computer-readable medium may include further operations, features, means, or instructions for transmitting, via the MIB message, an indication of a set of resources within the communication frame structure for communicating SIB messages and transmitting a SIB message within the set of resources and based on receiving the MIB message, where the SIB message indicates one or more parameters associated with the communication frame structure, where communicating the one or more messages may be based on the one or more parameters.

Some examples of the method, apparatuses, and non-transitory computer-readable medium described herein may further include operations, features, means, or instructions for transmitting, via the MIB message, an indication of a periodicity for transmitting the SIB message, where the SIB message may be received in accordance with the periodicity.

In some examples of the method, apparatuses, and non-transitory computer-readable medium described herein, the communication frame structure includes a set of multiple sets of resources usable for a set of multiple different types of communications and the control message indicates one or more parameters associated with the set of multiple sets of resources, the one or more parameters including a starting resource offset, an ending resource offset, a periodicity, a time interval, or any combination thereof.

In some examples of the method, apparatuses, and non-transitory computer-readable medium described herein, the communication frame structure includes a set of RACH resources and the method, apparatuses, and non-transitory computer-readable medium may include further operations, features, means, or instructions for communicating one or more random access messages with the passive device within the set of RACH resources as part of a random access procedure between the passive device and the first reader device, where communicating the one or more messages in accordance with the communication frame structure may be based on communicating the one or more random access messages.

In some examples of the method, apparatuses, and non-transitory computer-readable medium described herein, the communication frame structure includes a set of transport block resources for data communication between the passive device and the first reader device and the method, apparatuses, and non-transitory computer-readable medium may include further operations, features, means, or instructions for transmitting, via a first resource of the set of transport block resources, an additional control message indicating one or more parameters usable for communications within the set of transport block resources, the one or more parameters including a type of communication, a type of communication channel, a direction of communication, a length of communication, a modulation and coding scheme, a repetition metric, or any combination thereof, where the one or more messages may be communicated within the set of transport block resources in accordance with the one or more parameters.

Some examples of the method, apparatuses, and non-transitory computer-readable medium described herein may further include operations, features, means, or instructions for transmitting a synchronization signal message via the one or more continuous wave signals and determining a timing reference associated with a relative timing of communications between the first reader device and the passive device based on the synchronization signal message, where transmitting the control message, communicating the one or more messages, or both, may be based on the timing reference.

In some examples of the method, apparatuses, and non-transitory computer-readable medium described herein, the control message includes a MIB message, a SIB message, or both.

In some examples of the method, apparatuses, and non-transitory computer-readable medium described herein, the passive device includes a radio frequency identifier tag, a passive component of a wireless device, or both and the first reader device includes a user equipment (UE), a network entity, or both.

A method for wireless communication at a passive device is described. The method may include receiving a first message from a first reader device included within a network of reader devices, where the first message indicates a first reader identifier corresponding to the first reader device, receiving a second message from a second reader device included within the network of reader devices, where the second message indicates a second reader identifier corresponding to the second reader device, determining that the passive device has moved from a first tracking area associated with the first reader identifier to a second tracking area associated with the second reader identifier based on a comparison of the first reader identifier and a second reader identifier, and transmitting, to the second reader device, a third message including an identifier associated with the passive device based on determining that the passive device has moved to the second tracking area.

An apparatus for wireless communication at a passive device is described. The apparatus may include a processor, memory coupled with the processor, and instructions stored in the memory. The instructions may be executable by the processor to cause the apparatus to receive a first message from a first reader device included within a network of reader devices, where the first message indicates a first reader identifier corresponding to the first reader device, receive a second message from a second reader device included within the network of reader devices, where the second message indicates a second reader identifier corresponding to the second reader device, determine that the passive device has moved from a first tracking area associated with the first reader identifier to a second tracking area associated with the second reader identifier based on a comparison of the first reader identifier and a second reader identifier, and transmit, to the second reader device, a third message including an identifier associated with the passive device based on determining that the passive device has moved to the second tracking area.

Another apparatus for wireless communication at a passive device is described. The apparatus may include means for receiving a first message from a first reader device included within a network of reader devices, where the first message indicates a first reader identifier corresponding to the first reader device, means for receiving a second message from a second reader device included within the network of reader devices, where the second message indicates a second reader identifier corresponding to the second reader device, means for determining that the passive device has moved from a first tracking area associated with the first reader identifier to a second tracking area associated with the second reader identifier based on a comparison of the first reader identifier and a second reader identifier, and means for transmitting, to the second reader device, a third message including an identifier associated with the passive device based on determining that the passive device has moved to the second tracking area.

A non-transitory computer-readable medium storing code for wireless communication at a passive device is described. The code may include instructions executable by a processor to receive a first message from a first reader device included within a network of reader devices, where the first message indicates a first reader identifier corresponding to the first reader device, receive a second message from a second reader device included within the network of reader devices, where the second message indicates a second reader identifier corresponding to the second reader device, determine that the passive device has moved from a first tracking area associated with the first reader identifier to a second tracking area associated with the second reader identifier based on a comparison of the first reader identifier and a second reader identifier, and transmit, to the second reader device, a third message including an identifier associated with the passive device based on determining that the passive device has moved to the second tracking area.

Some examples of the method, apparatuses, and non-transitory computer-readable medium described herein may further include operations, features, means, or instructions for determining a first set of parameters associated with the first message received from the first reader device, and a second set of parameters associated with the second message received from the second reader device, determining to perform a handover procedure from the first reader device to the second reader device based on a comparison of the first set of parameters and the second set of parameters, and perform a random access procedure with the second reader device based on determining to perform the handover procedure from the first reader device to the second reader device.

Some examples of the method, apparatuses, and non-transitory computer-readable medium described herein may further include operations, features, means, or instructions for determining a difference between the first reader identifier and the second reader identifier, where determining that the passive device may have moved from the first tracking area associated with the first reader identifier to the second tracking area may be based on the difference satisfying a threshold difference.

Some examples of the method, apparatuses, and non-transitory computer-readable medium described herein may further include operations, features, means, or instructions for receiving a continuous wave signal from the second reader device via a frequency channel, receiving, from the second reader device via the continuous wave signal and based on activating radio frequency circuitry of the passive device in response to the continuous wave signal, a control message indicating a communication frame structure including resources usable for time-domain multiplexed communications between the passive device and the second reader device via the frequency channel, and communicating one or more messages with the second reader device in accordance with the communication frame structure, the one or more messages including the second message, where the one or more messages may be modulated by the second reader device via the continuous wave signal, backscattered by the passive device based on the continuous wave signal, or both.

Some examples of the method, apparatuses, and non-transitory computer-readable medium described herein may further include operations, features, means, or instructions for receiving, via the control message, a device identifier associated with the passive device, a set of passive devices including the passive device, or both, where communicating the one or more messages in accordance with the communication frame structure may be based on receiving the device identifier.

In some examples of the method, apparatuses, and non-transitory computer-readable medium described herein, the communication frame structure includes a set of resources usable for transmitting scheduling requests and the method, apparatuses, and non-transitory computer-readable medium may include further operations, features, means, or instructions for transmitting a scheduling request to the second reader device via the set of resources, the scheduling request including an indication of uplink data to be communicated from the passive device to the second reader device, where communicating the one or more messages include transmitting the one or more messages including the uplink data.

Some examples of the method, apparatuses, and non-transitory computer-readable medium described herein may further include operations, features, means, or instructions for receiving, from the second reader device based on the scheduling request, scheduling information for communicating the uplink data, where the one or more messages may be transmitted in accordance with the scheduling information.

Some examples of the method, apparatuses, and non-transitory computer-readable medium described herein may further include operations, features, means, or instructions for receiving, via the control message, an additional control message, or both, an indication of a scheduling request sequence associated with the passive device, where transmitting the scheduling request includes backscattering the continuous wave signal in accordance with the scheduling request sequence.

Some examples of the method, apparatuses, and non-transitory computer-readable medium described herein may further include operations, features, means, or instructions for receiving, via the control message, an indication of one or more trigger conditions for transmitting uplink data to the second reader device, collecting data using one or more sensors associated with the passive device, and transmitting the one or more messages including the uplink data to the second reader device based on the data satisfying the one or more trigger conditions.

Some examples of the method, apparatuses, and non-transitory computer-readable medium described herein may further include operations, features, means, or instructions for receiving, via the control message, an indication of a scheduling cycle periodicity associated with the communication frame structure, where communicating the one or more messages in accordance with the communication frame structure may be based on the scheduling cycle periodicity.

In some examples of the method, apparatuses, and non-transitory computer-readable medium described herein, the control message includes a MIB message and the method, apparatuses, and non-transitory computer-readable medium may include further operations, features, means, or instructions for receiving, via the MIB message, an indication of a set of resources within the communication frame structure for communicating SIB messages and receiving a SIB message within the set of resources and based on receiving the MIB message, where the SIB message indicates one or more parameters associated with the communication frame structure, where communicating the one or more messages may be based on the one or more parameters.

Some examples of the method, apparatuses, and non-transitory computer-readable medium described herein may further include operations, features, means, or instructions for receiving, via the MIB message, an indication of a periodicity for receiving the SIB message, where the SIB message may be received in accordance with the periodicity.

In some examples of the method, apparatuses, and non-transitory computer-readable medium described herein, the communication frame structure includes a set of multiple sets of resources usable for a set of multiple different types of communications and the control message indicates one or more parameters associated with the set of multiple sets of resources, the one or more parameters including a starting resource offset, an ending resource offset, a periodicity, a time interval, or any combination thereof.

In some examples of the method, apparatuses, and non-transitory computer-readable medium described herein, the communication frame structure includes a set of RACH resources and the method, apparatuses, and non-transitory computer-readable medium may include further operations, features, means, or instructions for communicating one or more random access messages with the second reader device within the set of RACH resources as part of a random access procedure between the passive device and the second reader device, where communicating the one or more messages in accordance with the communication frame structure may be based on communicating the one or more random access messages.

In some examples of the method, apparatuses, and non-transitory computer-readable medium described herein, the communication frame structure includes a set of transport block resources for data communication between the passive device and the second reader device and the method, apparatuses, and non-transitory computer-readable medium may include further operations, features, means, or instructions for receiving, via a first resource of the set of transport block resources, an additional control message indicating one or more parameters usable for communications within the set of transport block resources, the one or more parameters including a type of communication, a type of communication channel, a direction of communication, a length of communication, a modulation and coding scheme, a repetition metric, or any combination thereof, where the one or more messages may be communicated within the set of transport block resources in accordance with the one or more parameters.

Some examples of the method, apparatuses, and non-transitory computer-readable medium described herein may further include operations, features, means, or instructions for receiving a synchronization signal message via the continuous wave signal and determining a timing reference associated with a relative timing of communications between the second reader device and the passive device based on the synchronization signal message, where receiving the control message, communicating the one or more messages, or both, may be based on the timing reference.

In some examples of the method, apparatuses, and non-transitory computer-readable medium described herein, the control message includes a MIB message, a SIB message, or both.

In some examples of the method, apparatuses, and non-transitory computer-readable medium described herein, the passive device includes a radio frequency identifier tag, a passive component of a wireless device, or both and the second reader device includes a UE, a network entity, or both.

A method for wireless communication at a wireless device is described. The method may include identifying data to be communicated to a passive device that is communicatively couplable to a network of reader devices, identifying a first reader device from the network of reader devices that was previously communicatively coupled with the passive device based on referencing a data object that includes mappings between a set of multiple passive devices and corresponding current reader devices from the network of reader devices, transmitting the data to the first reader device along with an instruction to either relay the data to the passive device or identify a second reader device that is communicatively coupled with the passive device, and receiving a message indicating the first reader device or the second reader device as the current reader device corresponding to the passive device.

An apparatus for wireless communication at a wireless device is described. The apparatus may include a processor, memory coupled with the processor, and instructions stored in the memory. The instructions may be executable by the processor to cause the apparatus to identify data to be communicated to a passive device that is communicatively couplable to a network of reader devices, identify a first reader device from the network of reader devices that was previously communicatively coupled with the passive device based on referencing a data object that includes mappings between a set of multiple passive devices and corresponding current reader devices from the network of reader devices, transmit the data to the first reader device along with an instruction to either relay the data to the passive device or identify a second reader device that is communicatively coupled with the passive device, and receive a message indicating the first reader device or the second reader device as the current reader device corresponding to the passive device.

Another apparatus for wireless communication at a wireless device is described. The apparatus may include means for identifying data to be communicated to a passive device that is communicatively couplable to a network of reader devices, means for identifying a first reader device from the network of reader devices that was previously communicatively coupled with the passive device based on referencing a data object that includes mappings between a set of multiple passive devices and corresponding current reader devices from the network of reader devices, means for transmitting the data to the first reader device along with an instruction to either relay the data to the passive device or identify a second reader device that is communicatively coupled with the passive device, and means for receiving a message indicating the first reader device or the second reader device as the current reader device corresponding to the passive device.

A non-transitory computer-readable medium storing code for wireless communication at a wireless device is described. The code may include instructions executable by a processor to identify data to be communicated to a passive device that is communicatively couplable to a network of reader devices, identify a first reader device from the network of reader devices that was previously communicatively coupled with the passive device based on referencing a data object that includes mappings between a set of multiple passive devices and corresponding current reader devices from the network of reader devices, transmit the data to the first reader device along with an instruction to either relay the data to the passive device or identify a second reader device that is communicatively coupled with the passive device, and receive a message indicating the first reader device or the second reader device as the current reader device corresponding to the passive device.

Some examples of the method, apparatuses, and non-transitory computer-readable medium described herein may further include operations, features, means, or instructions for updating the data object based on receiving the message.

In some examples of the method, apparatuses, and non-transitory computer-readable medium described herein, the network entity includes a base station, a home reader associated with the passive device, or both.

### BRIEF DESCRIPTION OF THE DRAWINGS

FIG. 1 illustrates an example of a wireless communications system that supports channel and frame structures for zero-power passive devices in accordance with one or more aspects of the present disclosure.

FIG. 2 illustrates another example of a wireless communication system that supports channel and frame structures for zero-power passive devices in accordance with one or more aspects of the present disclosure.

FIG. 3 illustrates an example of a communication frame structure that supports channel and frame structures for zero-power passive devices in accordance with one or more aspects of the present disclosure.

FIG. 4 illustrates an example of a process flow that supports channel and frame structures for zero-power passive devices in accordance with one or more aspects of the present disclosure.

FIG. 5 illustrates an example of another process flow that supports channel and frame structures for zero-power passive devices in accordance with one or more aspects of the present disclosure.

FIGS. 6 and 7 illustrate block diagrams of devices that support channel and frame structures for zero-power passive devices in accordance with one or more aspects of the present disclosure.

FIG. 8 illustrates a block diagram of a communications manager that supports channel and frame structures for zero-power passive devices in accordance with one or more aspects of the present disclosure.

FIG. 9 illustrates a diagram of a system including a device that supports channel and frame structures for zero-power passive devices in accordance with one or more aspects of the present disclosure.

FIGS. 10 and 11 illustrate block diagrams of devices that support channel and frame structures for zero-power passive devices in accordance with one or more aspects of the present disclosure.

FIG. 12 illustrates a block diagram of a communications manager that supports channel and frame structures for zero-power passive devices in accordance with one or more aspects of the present disclosure.

FIG. 13 illustrates a diagram of a system including a device that supports channel and frame structures for zero-power passive devices in accordance with one or more aspects of the present disclosure.

FIG. 14 illustrates a flowchart showing methods that support channel and frame structures for zero-power passive devices in accordance with one or more aspects of the present disclosure.

### DETAILED DESCRIPTION

Some wireless communications systems may include passive devices, such as radio frequency identifier (RFID) tags, to perform certain operations such as location tracking and identification. Passive devices may not have their own power sources, but may receive power from continuous wave signals transmitted by reader devices. For example, a reader device may transmit a continuous wave signal to a passive device, where the passive device uses energy from the continuous wave signal to activate radio frequency components and reflect (e.g., backscatter) the continuous wave signal back to the reader device. In some cases, passive devices are configured to backscatter an identifier (e.g., the RFID) associated with the passive device on the same channel that was used to communicate the continuous wave signal. However, current communications systems do not have any signaling or mechanisms to locate passive devices within a network, such as tags that are able to move within the network for tracking purposes.

Additionally, in some wireless communications systems, there is no formal communication frame structure used for communications between passive devices and reader devices. That is, passive devices are simply configured to respond with the corresponding RFID when queried. However, some passive devices may be configured to collect data, and feed collected data back to reader devices. In such cases, without a formal communication structure between the passive devices and the reader devices, it may be unclear as to what resources should be used by the passive device to return uplink data to the reader device.

Accordingly, as disclosed herein, signaling may be used for locating passive devices using a network of reader devices, as well as for enabling reader devices to configure passive devices with communication frame structures that are used for wireless communications between the respective devices. For example, upon identifying data to be sent to a passive device, a network node or a home reader device may identify a current or last-known reader device associated with the passive device by referencing a table or other data object. Subsequently, the current/last-known reader device may attempt to relay the data to the reader device, and may relay the data to surrounding reader devices if the reader device is unable to locate the tag. In cases where the passive device is associated with a new reader device, the respective devices may inform the network node or home reader to update the table accordingly.

Upon identifying a passive device, a reader device may transmit a continuous wave signal that is configured to activate radio frequency circuitry at a passive device. The reader device may subsequently modulate a control message (e.g., master information block (MIB), system information block (SIB)) on top of the continuous wave signal. The control message may indicate a communication frame structure including resources usable for time-domain multiplexed communications between the respective devices on the same channel that was used to communicate the continuous wave signal and control message. The communication frame structure may include resources for random access channel (RACH) communications, scheduling requests (SRs) from the passive device, resources for exchange of transport blocks (e.g., uplink/downlink messages), and the like. As such, the communication frame structure may enable the devices to identify which time-domain resources should be used for various types of signaling. In some cases, the passive device may be configured with a SR message or sequence that the passive device is to use when transmitting SRs so that the reader device knows which passive device is requesting to be scheduled.

Aspects of the disclosure are initially described in the context of wireless communications systems. Aspects of the disclosure are further illustrated by and described with reference to apparatus diagrams, system diagrams, and flowcharts that relate to channel and frame structures for zero-power passive devices.

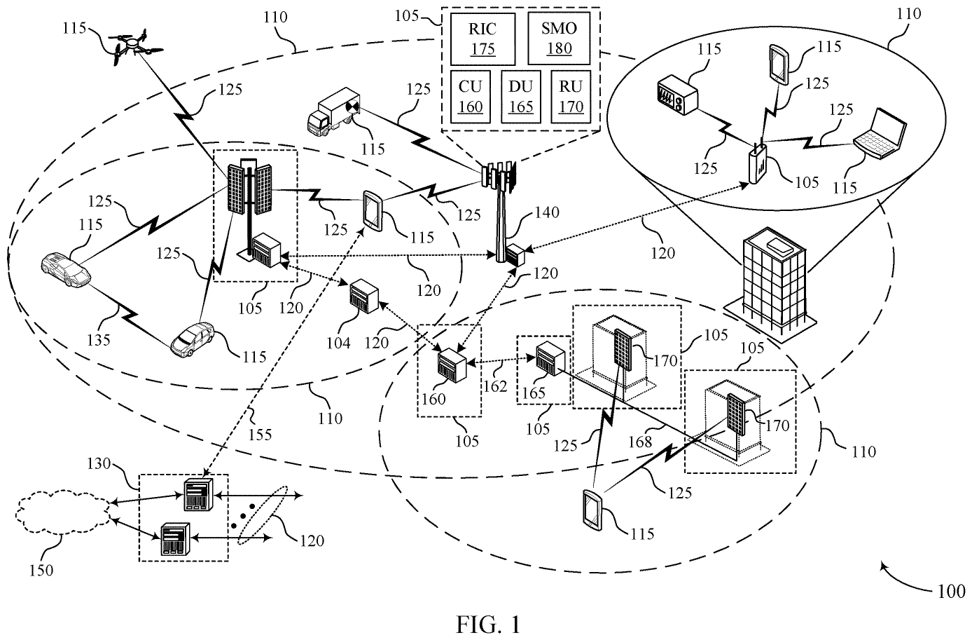

FIG. 1 illustrates an example of a wireless communications system 100 that supports channel and frame structures for zero-power passive devices in accordance with one or more aspects of the present disclosure. The wireless communications system 100 may include one or more network nodes 105, one or more user equipments (UEs) 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network nodes 105 may be dispersed throughout a geographic area to form the wireless communications system 100 and may include devices in different forms or having different capabilities. In various examples, a network node 105 may be referred to as a network element, a mobility element, a radio access network (RAN) node, or network equipment, among other nomenclature. In some examples, network nodes 105 and UEs 115 may wirelessly communicate via one or more communication links 125 (e.g., a radio frequency (RF) access link). For example, a network node 105 may support a coverage area 110 (e.g., a geographic coverage area) over which the UEs 115 and the network node 105 may establish one or more communication links 125. The coverage area 110 may be an example of a geographic area over which a network node 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network nodes 105, as shown in FIG. 1.

As described herein, a node of the wireless communications system 100, which may be referred to as a network node, or a wireless node, may be a network node 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network node 105. As another example, a first node may be configured to communicate with a second node or a third node. In one aspect of this example, the first node may be a UE 115, the second node may be a network node 105, and the third node may be a UE 115. In another aspect of this example, the first node may be a UE 115, the second node may be a network node 105, and the third node may be a network node 105. In yet other aspects of this example, the first, second, and third nodes may be different relative to these examples. Similarly, reference to a UE 115, network node 105, apparatus, device, computing system, or the like may include disclosure of the UE 115, network node 105, apparatus, device, computing system, or the like being a node. For example, disclosure that a UE 115 is configured to receive information from a network node 105 also discloses that a first node is configured to receive information from a second node.

In some examples, network nodes 105 may communicate with the core network 130, or with one another, or both. For example, network nodes 105 may communicate with the core network 130 via one or more backhaul communication links 120 (e.g., in accordance with an S1, N2, N3, or other interface protocol). In some examples, network nodes 105 may communicate with one another via a backhaul communication link 120 (e.g., in accordance with an X2, Xn, or other interface protocol) either directly (e.g., directly between network nodes 105) or indirectly (e.g., via a core network 130). In some examples, network nodes 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network nodes 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network node 105 (e.g., a base station 140) may be implemented in an aggregated (e.g., monolithic, standalone) base station architecture, which may be configured to utilize a protocol stack that is physically or logically integrated within a single network node 105 (e.g., a single RAN node, such as a base station 140).

In some examples, a network node 105 may be implemented in a disaggregated architecture (e.g., a disaggregated base station architecture, a disaggregated RAN architecture), which may be configured to utilize a protocol stack that is physically or logically distributed among two or more network nodes 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network nodes 105 in a disaggregated RAN architecture may be co-located, or one or more components of the network nodes 105 may be located in distributed locations (e.g., separate physical locations). In some examples, one or more network nodes 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network nodes 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network nodes 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network node 105 (e.g., a donor base station 140). The one or more donor network nodes 105 (e.g., IAB donors) may be in communication with one or more additional network nodes 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support channel and frame structures for zero-power passive devices as described herein. For example, some operations described as being performed by a UE 115 or a network node 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network nodes 105 and the network equipment including macro eNBs or gNBs, small cell eNBs or gNBs, or relay base stations, among other examples, as shown in FIG. 1.

The UEs 115 and the network nodes 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network node 105 and other devices may refer to communication between the devices and any portion (e.g., entity, sub-entity) of a network node 105. For example, the terms “transmitting,” “receiving,” or “communicating,” when referring to a network node 105, may refer to any portion of a network node 105 (e.g., a base station 140, a CU 160, a DU 165, a RU 170) of a RAN communicating with another device (e.g., directly or via one or more other network nodes 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network node 105 to a UE 115, uplink transmissions (e.g., return link transmissions) from a UE 115 to a network node 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network nodes 105, the UEs 115, or both) may have hardware configurations that support communications using a particular carrier bandwidth or may be configurable to support communications using one of a set of carrier bandwidths. In some examples, the wireless communications system 100 may include network nodes 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network nodes 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network node 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network node 105. In some other examples, the overlapping coverage areas 110 associated with different technologies may be supported by different network nodes 105. The wireless communications system 100 may include, for example, a heterogeneous network in which different types of the network nodes 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network node 105 (e.g., a base station 140, an RU 170), which may support aspects of such D2D communications being configured by (e.g., scheduled by) the network node 105. In some examples, one or more UEs 115 of such a group may be outside the coverage area 110 of a network node 105 or may be otherwise unable to or not configured to receive transmissions from a network node 105. In some examples, groups of the UEs 115 communicating via D2D communications may support a one-to-many (1:M) system in which each UE 115 transmits to each of the other UEs 115 in the group. In some examples, a network node 105 may facilitate the scheduling of resources for D2D communications. In some other examples, D2D communications may be carried out between the UEs 115 without an involvement of a network node 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network nodes 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network nodes 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network nodes 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network node 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network node 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network node 105 may be located at diverse geographic locations. A network node 105 may include an antenna array with a set of rows and columns of antenna ports that the network node 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network nodes 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network node 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network node 105 or a UE 115 may use beam sweeping techniques as part of beamforming operations. For example, a network node 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network node 105 multiple times along different directions. For example, the network node 105 may transmit a signal according to different beamforming weight sets associated with different directions of transmission. Transmissions along different beam directions may be used to identify (e.g., by a transmitting device, such as a network node 105, or by a receiving device, such as a UE 115) a beam direction for later transmission or reception by the network node 105.

Some signals, such as data signals associated with a particular receiving device, may be transmitted by transmitting device (e.g., a transmitting network node 105, a transmitting UE 115) along a single beam direction (e.g., a direction associated with the receiving device, such as a receiving network node 105 or a receiving UE 115). In some examples, the beam direction associated with transmissions along a single beam direction may be determined based on a signal that was transmitted along one or more beam directions. For example, a UE 115 may receive one or more of the signals transmitted by the network node 105 along different directions and may report to the network node 105 an indication of the signal that the UE 115 received with a highest signal quality or an otherwise acceptable signal quality.

In some examples, transmissions by a device (e.g., by a network node 105 or a UE 115) may be performed using multiple beam directions, and the device may use a combination of digital precoding or beamforming to generate a combined beam for transmission (e.g., from a network node 105 to a UE 115). The UE 115 may report feedback that indicates precoding weights for one or more beam directions, and the feedback may correspond to a configured set of beams across a system bandwidth or one or more sub-bands. The network node 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network node 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network node 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network node 105 or a core network 130 supporting radio bearers for user plane data. A PHY layer may map transport channels to physical channels.

The UEs 115 and the network nodes 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the wireless communication system 100 may support communication with zero-power internet of things (IoT) devices, such as passive devices. For example, in some cases, the wireless communications system 100 may include passive devices, where the passive devices may be located using signaling within a network of reader devices (e.g., network nodes 105, UEs 115, etc.) supported by the wireless communications system 100. The signaling may enable reader devices to configure the passive devices with communication frame structures that are used for wireless communications between the respective devices. For example, upon identifying data to be sent to a passive device, a network node 105 or a “home” reader device may identify a “current” or “last-known” reader device associated with the passive device by referencing a table or other data object. Subsequently, the last-known reader device may attempt to relay the data to the passive device. In some examples, the last-known reader device may relay the data to surrounding reader devices if the last-known reader device is unable to locate the passive device. In some examples, where the passive device is associated with a new reader device, the respective devices may inform the network node or home reader to update the table accordingly.

Upon identifying a passive device, a reader device may transmit a continuous wave signal that is configured to activate radio frequency circuitry at a passive device. The reader device may subsequently modulate a control message (e.g., MIB, SIB) on top of the continuous wave signal. The control message may indicate a communication frame structure including resources usable for time-domain multiplexed communications between the respective devices on the same channel that was used to communicate the continuous wave signal and control message. The communication frame structure may include RACH communications, SRs from the passive device, resources for exchange of transport blocks (e.g., uplink/downlink messages), and the like. As such, the communication frame structure may enable the devices to identify which time-domain resources should be used for various types of signaling. In some cases, the passive device may be configured with a SR message or sequence that the passive device is to use when transmitting SRs so that the reader device knows which passive device is requesting to be scheduled. Moreover, in some aspects, the SR message may indicate a quantity of uplink data that is to be transmitted by the passive device.

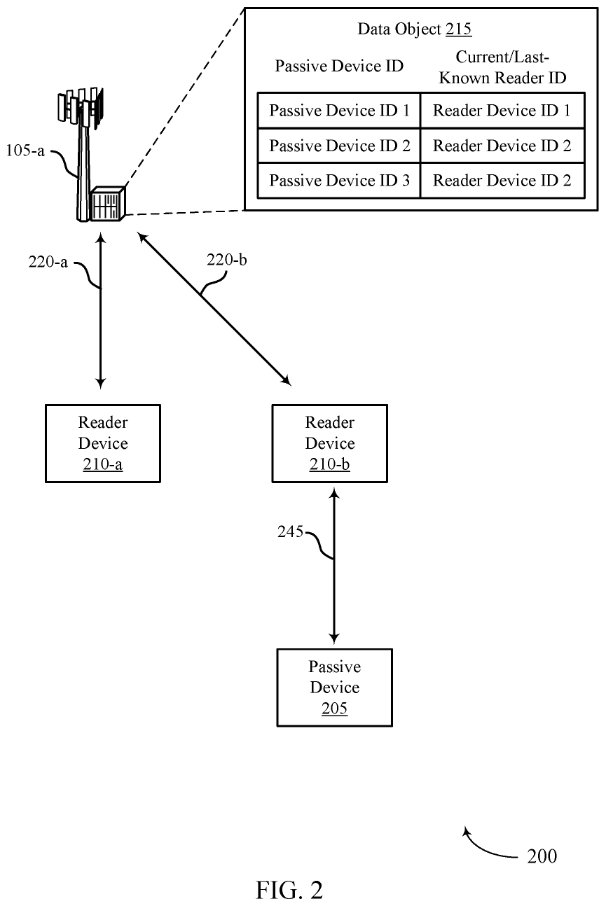

FIG. 2 illustrates an example of a wireless communications system 200 that supports channel and frame structures for zero-power passive devices in accordance with one or more aspects of the present disclosure. In some examples, aspects of the wireless communications system 200 may implement, or be implemented by, aspects of the wireless communications system 100. In particular, the wireless communications system 200 may support signaling, configurations, and other mechanisms which enable locating passive devices using a network of reader devices, as well as enabling reader devices to configure passive devices with communication frame structures, as described with respect to FIG. 1.

The wireless communications system 200 may include a network node 105-a, a first reader device 210-a, a second reader device 210-b, a passive device 205, and a data object 215. The network node 105-a may be an example of the network node 105, as described with respect to FIG. 1. Generally, a reader device 210 may include RFID devices, which may include a reader and a tag.

In some aspects, the passive device 205 (e.g., passive or zero-power IoT (ZP-IoT) device) may include a lower-complexity device (e.g., <100 μW device), such as a RFID tag, a passive IoT device, a hybrid device including passive and active components, passive components of querying/active devices (e.g., passive components of a UE 115), and the like. In some examples, the passive device 205 may be used to collect data, and/or may be attached to an object for location tracking. In some cases, the passive device 205 may or may not include a power source such as a battery. In some examples, the passive device 205, the reader devices 210, or both, may be operable in unlicensed frequency bands, for example, in 902-928 megahertz (MHz).

In some aspects, the passive device 205 may include a ZP-IoT device that does not include a battery or other power source. In such cases, the passive device 205 may extract energy from signals (e.g., continuous wave signals) received from the network node 105-a, the reader devices 210, or both. For example, the reader device 210-a may transmit a signal in a forward link or forward communication to the passive device 205, as further discussed herein. The passive device 205 may communicate with the reader device 210-a in a backscatter communication or a backscatter link, as further discussed herein. In some examples, where the passive device 205 is a ZP-IoT device, signals that provide energy for power may be directly provided from the network node 105-a to the passive device 205 or from the reader device 210 to the passive device 205 in a downlink communication. The ZP-IoT device may communicate signals in multiple frequency ranges, for example, in a subband 1 gigahertz (GHz) (e.g., 700 MHZ, 900 MHz) in a frequency division duplexing (FDD), or in a subband 6 GHz (e.g., 3.5 GHZ) for time division duplexing (TDD).

In some examples, passive device 205 may include battery-less or limited energy storage (e.g., capacitor) devices capable of wireless communication. As it is used herein, the term “passive device” may be used to refer to devices which may utilize passive signaling for performance of transmissions by the passive device 205, actively powered radio signals for performance of transmissions by the passive device 205, or both. In this regard, the passive device 205 may receive power for performance of transmissions from radio frequency signals received from other devices, from power sources associated with the passive device 205, or both, as will be described in further detail herein. Moreover, as it is used herein, the terms “querying device,” “reader device 210,” “RF source,” or any combination thereof, may refer to wireless devices (e.g., UEs 115, network nodes 105, IAB nodes, etc.) that are configured to communicate with passive devices 205, such as by transmitting signals (e.g., queries, commands, continuous wave signals) to passive devices 205, receiving/reading signals from passive devices 205, and the like.

The passive device 205 may be used to support various services and applications within the wireless communications system 200, such as identification, tracking, the like. Other use cases that may be supported or facilitated by the passive device 205 may include power sourcing, security applications, access control or access connectivity management, positioning services, and the like. The passive device 205 may be capable of communicating over different frequency ranges, such as UHF ranges.

The reader devices 210-a and 210-b may communicate with the network node 105-a using communication links 220-a and 220-b, respectively, which may be examples of NR or LTE links between the respective reader devices 210 and the network node 105-a. In some examples, the reader devices 210 may include UEs 115, network nodes 105, or a dedicated relay device. In some cases, the communication links 220 may include examples of access links (e.g., Uu links) which may include bi-directional links that enable both uplink and downlink communication.

For example, the first reader device 210-a may transmit uplink signals, such as uplink control signals or uplink data signals, to one or more components of the network node 105-a using the communication link 220-a, and one or more components of the network node 105-a may transmit downlink signals, such as downlink control signals or downlink data signals, to the first reader device 210-a using the communication link 220-a. Similarly, the second reader device 210-b and the network node 105-a may communicate with one another using a communication link 220-b. Further, in some aspects, each of the reader devices 210 may communicate with one another via communication links, such as sidelink communication links or PC5 links.

In some aspects, the respective wireless devices of the wireless communications system 200 (e.g., network node 105-a, reader devices 210, passive devices 205) may communicate with one another via energy harvesting and backscatter communication. For example, the passive devices 205 may support Energy Harvesting Enabled Communication Services (EHECS) in 5GS. The terms “forward communication” or “forward link” and “backscatter communication” or “backscatter link” may refer to a relative direction of communication between a reader device 210 and a passive device 205. For example, in the context of backscatter communication, the first reader device 210-a (e.g., querying device) may transmit a signal or query to the passive device 205 via a forward link of a communication link, and the passive device 205 may transmit a backscattered message via a backscatter link of the communication link. To perform a backscattered communication, the passive device 205 may vary an impedance of radio frequency circuitry in response to a signal (e.g., continuous wave signal) in order to “backscatter” data (e.g., 0s and 1s) to the respective reader device 210-a via the received signal.

As noted previously herein, in some implementations, passive devices 205 may include relatively low-complexity devices which may or may not include a power amplifier and/or a battery. In some cases, passive devices 205 may include antennas (e.g., dipole antennas) and other circuitry (e.g., integrated circuit, chip, load) used to facilitate wireless communications. In some aspects, the range over which a passive device 205 can transmit a message (e.g., backscattered signal) may depend on the manner in which the respective passive device 205 is powered. For example, in some cases, a passive device 205 may not include a power source, but may instead receive power from wireless communications received from querying devices and may transmit far-field signals or modulate reflected signals using power absorbed or extracted from signals received from querying devices. In such cases, the range of such passive devices 205 may be limited to less than ten meters.

In some aspects, passive devices 205 may receive or generate power used for wireless communications and other operations using a rectifier, where a rectifier may include a diode and a capacitor. For example, a passive device 205 may receive a signal from a querying device (e.g., UE 115, network node 105-a) via an antenna, where power absorbed from the antenna is directed to a power rectifier. In this example, the power rectifier converts absorbed power from the antenna to rectified power, which may be directed back to the antenna to transmit messages (e.g., transmit backscattered signals). In some cases, a power rectifier may exhibit an energy conservation efficiency of approximately thirty percent.

Power absorbed via an antenna of a passive device 205 may be directed from the antenna through an amplitude-shift keying (ASK) or phase-shift keying (PSK) modulator to the power rectifier. In order to perform signal modulation within a passive device 205, an ASK modulator may exhibit two different states. In a first state (e.g., matched load state), an integrated circuit or antenna resistance of the ASK modulator matches backscatter power (e.g., radiation power matches or equals power absorbed by the integrated circuit). Comparatively, in a second state (e.g., unmated load state, or open circuit state), the integrated circuit or antenna resistance of the ASK modulator does not match the backscatter power. The modulation efficiency of an ASK modulator may be defined by Modulation Efficiency=Practical/Idealized Radiation Power.

In some aspects, communications between the passive device 205 and the reader devices 210 may utilize data transmission protocols associated with other networks, such as MAC, RLC, and/or PDCP communication protocols. In some aspects, MAC protocols may be used for HARQ communications (e.g., downlink HARQ), where only one default radio bearer (DRB) is supported, and where no multiplexing is required or expected. RLC protocols may support “stop-and-go” communications, as opposed to a sliding window automatic repeat request (ARQ), in order to save buffer space (assuming the passive device 205 supports a low data rate). In the context of PDCP protocols, there may be no reordering, which may be left to higher-layer protocols. Further, with PDCP protocols, there may be no need for sequencing due to the stop-and-go ARQ communications.

Taken together, such communications protocols may provide for a single, combined user-plane layer to simplify communications between the passive device 205 and the reader device 210. For example, a transmitter device (e.g., reader device 210 or passive device 205) may perform header compression, integrity protection, ciphering, segmentation, and ARQ to generate signals transmitted to a receiver device (e.g., passive device 205 or reader device 210) over the PHY layer. Conversely, the received device may receive the signals via the physical layer and may perform ARQ, reassembly, deciphering, integrity verification, and header decompression.

The querying devices (e.g., reader devices 210, network node 105-a) and passive devices 205 may communicate with one another by exchanging unmodulated and modulated signals or waves (e.g., commands). In particular, a querying device may transmit a continuous wave signal to a passive device 205 to power up the respective passive device 205, and may transmit modulated commands or packets to instruct the passive device 205 to perform write operations, read operations, or both. Moreover, the passive device 205 may convert absorbed power from continuous wave signals (e.g., power absorbed from unmodulated signals) to transmit a modulated wave or message as a response to a received command. The passive devices 205 may receive data over one or a set of frequency bands. However, a passive device 205 may transmit data over one carrier frequency in a time domain.

As previously mentioned, the reader device 210 may relay signals to the passive device 205. As illustrated in FIG. 2, the reader device 210-b may transmit signals to, or receive signals from, the passive device 205 over a communication link 245, where the communication link 245 may be examples of PC5 or Uu links. Passive device 205 may be mobile and move within the network.

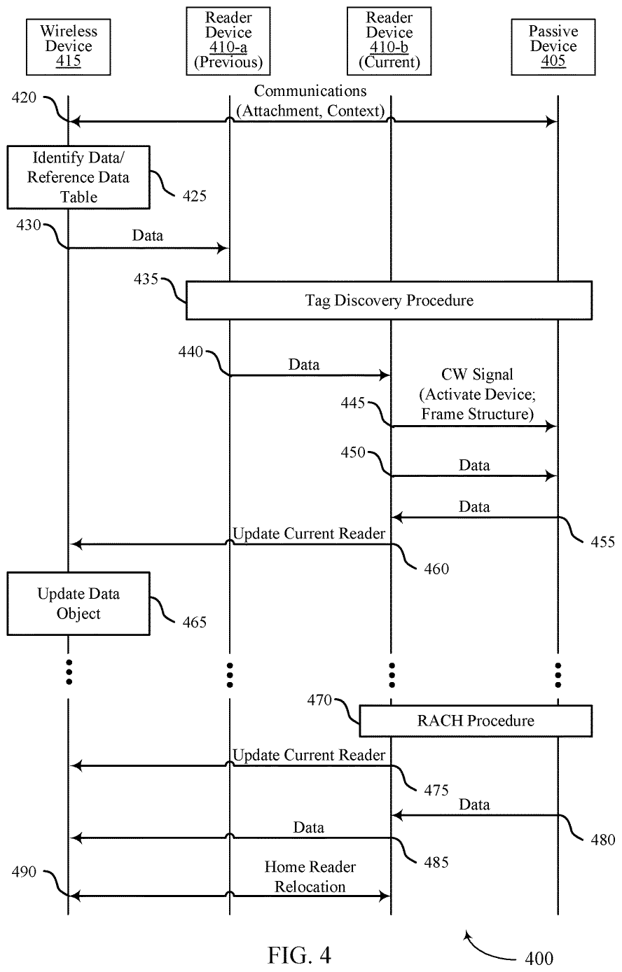

To facilitate tracking passive devices 205 for efficient communication between reader devices 210 and passive devices 205, a data object 215 may be used. The data object 215 may include a table or a similar relational database stored or otherwise accessible by the network node 105. In some examples, the data object 215 may be stored or otherwise accessible by a home reader (e.g., reader device 210-a, 210-b), as described with respect to FIG. 4. The data object 215 may store data indicating the passive device ID of a passive device 205 corresponding to a current or last-known reader device ID of a reader device 210. For the purposes of the present disclosure, the term “last-known reader device” may refer to a reader device 210 which, according to the data object 215, was the last reader device that was communicatively coupled to the respective passive device 205. As such, the data object 215 may be referenced in order to identify reader devices 210 that may be used to relay data to the passive devices 205.

For example, a first passive ID (Passive Device ID 1) of a first passive device 205 is associated with a first reader ID (Reader Device ID 1), a second passive ID (Passive Device ID 2) of a second passive device 205 is associated with a second reader ID (Reader Device ID 2), and a third passive ID (Passive Device ID 3) of a third passive device 205 is associated with a third reader ID (Reader Device ID 2). The IDs may be unique IDs indicative of the respective passive devices 205 or the reader devices 210. The paired IDs may indicate a pair of passive device 205 and reader device 210 that may communicate with each other in an uplink or downlink communication, for example, over communication link 245.

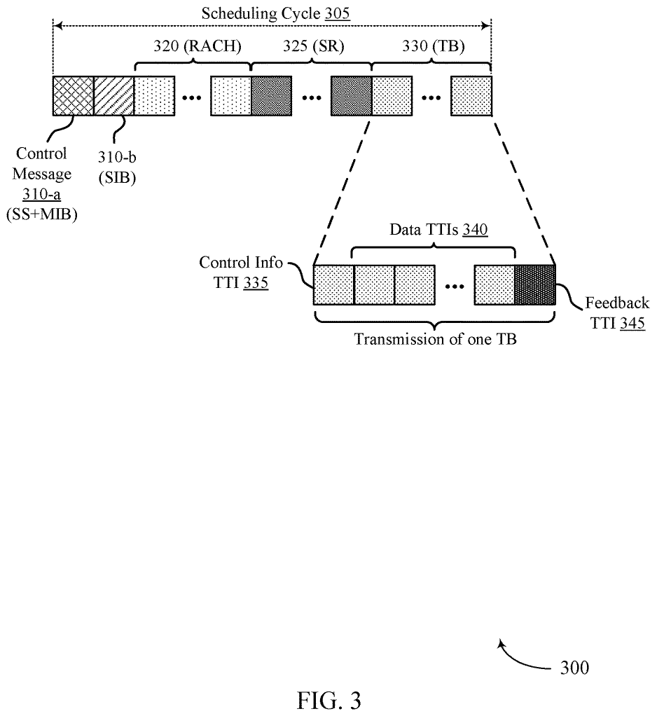

In some examples, the reader device ID for a reader device 210 paired with a particular passive device ID may change from an original or previous reader device ID to a new reader device ID. That is, the last known reader device ID may be updated from one ID to another, such as when a passive device 205 moves within the network and communicates with a new reader device 210. As illustrated, the last-known reader device ID for the third passive device ID (Passive Device ID 3) is the second reader device ID (Reader Device ID 2), which is also the last-known reader device ID for the second passive device ID (Passive Device ID 2). The previous reader device ID may have been a third reader device ID, which may have moved out of a threshold distance from the third passive device ID, and the second reader device ID may be the new and last-known reader now associated with the third passive device ID. In some examples, the data object 215 may be updated periodically or based upon a trigger event. In cases where the passive device 205 is associated with a new reader device 210 (e.g., moves from one reader device 210 to another), the respective devices may inform the network node 105 or home reader to update the table accordingly. Upon identifying a passive device 205, the corresponding reader device 210 may transmit a continuous wave signal that is configured to activate radio frequency circuitry at a passive device 205, as will be discussed with respect to FIG. 3.

The response from the passive device(s) 205 may include any type of data or information, and may depend on the type of passive device 205. Types of data/information that may be included within the response from the passive device(s) 205 may include, but is not limited to passive device 205 information such as a context with a control network or network node 105 (e.g., an addressable ID for the network node 105 to individually address and communicate with the passive device 205), available memory information associated with the respective passive device 205, sensing/metering/measurement information collected or acquired by the passive device 205, the reader device 210 linked or otherwise associated with the passive device 205 (e.g., current reader device 210 linked to the passive device 205), a type of item or product associated with the passive device 205, and the like.

In some examples, the data may be initiated in either uplink or downlink communications. For example, the passive device 205 may receive a query from an application via a control network, such as a via a network node 105 and/or a reader device 210, and the passive device 205 may transmit data uplink in the communication link 245 to be communicated to the application. The passive devices 205, such as passive devices 205 used for providing sensor or measuring data, may initiate uplink communication to transmit data based on a preconfigured trigger event or alert. In some examples, the data transmitted to or received from the passive device 205 may be infrequent, as well as small and delay-tolerant. In some examples, the passive device 205 may attempt to send data in the downlink communication or uplink communication that is too large to fit into a single transmission.

The passive devices 205 may be mobile and move from one location to another location. For example, the passive devices 205 may be mobile when used for logistic purposes or for asset tracking applications. In the context of connection management, passive devices 205 may benefit from some level of connection/context with the network, but may not be expected to maintain the same level of connection as compared to other wireless devices, such as UEs 115. For example, legacy RRC states used for UEs 115 may be too much overhead for passive devices 205. In particular, from the perspective of a passive device 205, the passive device 205 is always “on” or active, in that the passive device 205 is ready to transmit/receive data upon receiving a continuous wave signal from a reader device 210. Moreover, passive devices 205 may have only infrequent and/or small amounts of data to transmit or receive.

However, if the passive device 205 is mobile (e.g., able to move around within the network), the network (e.g., network entity 105-a) may be expected to maintain some type of “state” or context for the passive device 205. For example, a state/context may include information regarding whether there is a known link between the passive device 205 and a reader device. If not, the network entity 105-a may have to be able to locate the passive device 205 before data can be communicated to or from the passive device. In most contexts, data to/from the passive device 205 is delay tolerant and does not cost other passive devices 205 anything in case of “false paging alerts,” making it possible for the network to perform searches to identify and locate tags. Taken together, some techniques described herein may reuse the model used for small data transfer in RRC inactive states. In such state, the passive device 205 may stay in one “state” and may be always “connected” from the network's perspective.

Further, some aspects of the present disclosure are directed to techniques for locating tags within a network of reader devices 210. Generally, each respective passive device 205 may include or be associated with a respective context with the control network, such that each of the passive devices 205 are individually addressable. The passive devices may receive a 5G ID, such as a UE ID from the control network during an initial attachment to a respective reader device 210. In some examples, a control network may maintain a subscription to the passive device 205, for example, for paging for data. The passive devices 205 may be associated with a set quantity of memory (e.g., limited amount of memory). The protocols and messages, such as layer 2 (L2) or layer 3 (L3) protocols may have small memory footprints. As such, complex operations may be performed by the network. In some examples, as discussed herein, the reader devices 210 may communicate with each other within a network of reader devices 210. This capability my impact the techniques used for locating the passive devices 205 or for handing over a passive device 205 between the reader devices 210.

Some passive devices 205 may use energy from continuous wave signals from reader devices 210, respectively, to activate radio frequency components and “backscatter” the continuous wave signals back to the reader devices 210. In some cases, the passive devices 205 may backscatter IDs (e.g., RFID) associated with the passive devices 205 on the same channel that was used to communicate the continuous wave signals. However, current communications systems do not have any signaling or mechanisms to locate passive devices 205 within the network, such as passive devices 205 that are able to move within the network for tracking purposes.

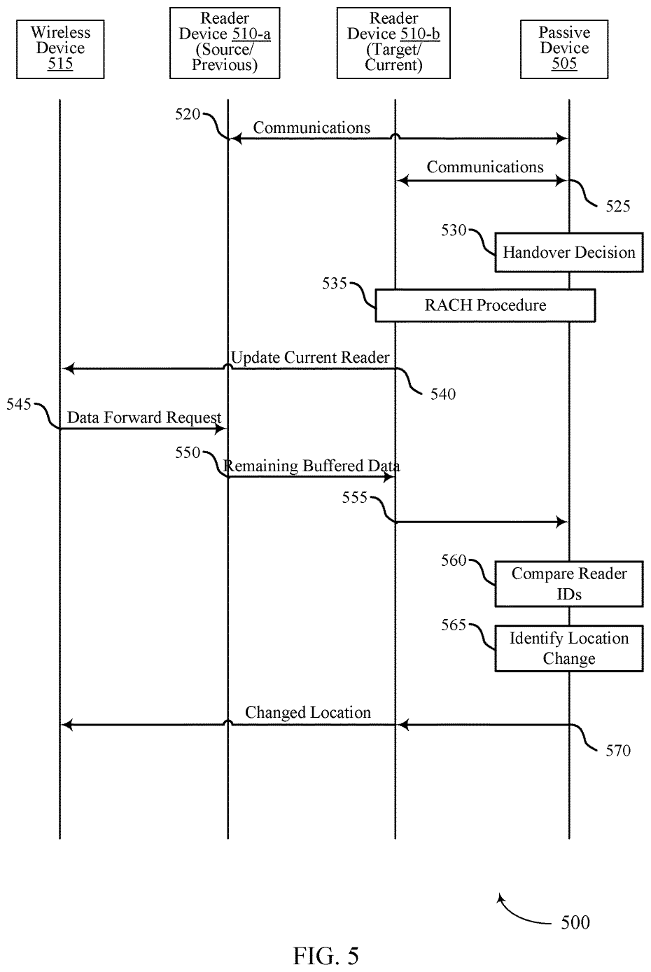

Accordingly, some aspects of the present disclosure are directed to signaling exchanged between the respective devices of the wireless communications system 200 to enable the passive device 205 to be identified within a network of reader devices, such as the reader devices 210-a and 210-b. Such concepts will be further shown and described with reference to FIGS. 4 and 5.

Additionally, in some wireless communications systems, no formal communication frame structure is used for communications between passive devices 205 and reader devices 210. However, some passive devices 205 may be configured to collect data, and feed collected data back to reader devices 210. In such cases, without a formal communication structure between the passive devices 205 and the reader devices 210, it may be unclear as to what resources should be used by the passive device 205 to return uplink data to the reader device 210.

Accordingly, additional or alternative aspects of the present disclosure are directed to signaling that enables reader devices 210 to configure passive devices 205 with communication frame structures that are used for communications between the respective devices. Such concepts will be further shown and described with reference to FIG. 3. FIG. 3 illustrates an example of a communication frame structure 300 that supports techniques for locating passive devices using a network of reader devices in accordance with one or more aspects of the present disclosure. Aspects of the communication frame structure 300 may implement, or be implemented by, aspects of the wireless communications system 100, the wireless communications system 200, or both.

When a passive device 205 is activated, the passive device 205 may communicate with the reader device 210 over a frequency band that is selected by the reader device 210. In particular, the reader device 210 may send a continuous wave signal over a frequency band/channel to the passive device 205 to activate the passive device 205, and the passive device 205 may transmit data to the reader device 210 over the same frequency band at which it received the continuous wave signal from the reader device 210 (e.g., by backscattering a message via the continuous wave signal). That is, the data is transmitted from the reader device 210 to the passive device 205 over a downlink communication, which includes a particular frequency band, and data is transmitted from the passive device 205 over an uplink communication including the particular frequency band. Since the uplink communication and the downlink communication between the reader device 210 and the passive device 205 occur over the same frequency band, the uplink transmission and the downlink transmission may time-division duplexed (e.g., occur at different time periods). The data communicated over the uplink communication and the downlink communication may be communicated in the communication frame structure 300 described herein.

The communication frame structure 300 may include resources that are allocated based on a scheduling cycle 305. The scheduling cycle 305 may be a pattern of allocating resources for exchanging data between the passive device 205 and the reader device 210. The resources may include resource elements that are grouped into symbols, which may be grouped into slots or other TTIs. In some examples, the minimum scheduling for the scheduling cycling is one slot.

In some aspects, the reader device 210 may transmit a continuous wave signal to the passive device 205 in order to activate radio frequency circuitry at the passive device 205. Subsequently, the reader device 210 may transmit, via the continuous wave signal, a first control message 310-a that indicates the communication frame structure 300 that will be used for communications between the respective devices. For example, the communication frame structure 300 for transmitting data, for example, from a reader device 210 to a passive device 205, may include a first or TTI that for communicating to a first control message 310-a. In some aspects, the first control message 310-a may include a synchronization signal (SS) block, as well as a MIB. The SS block and the MIB block or signals may be sent at the beginning of each scheduling cycle 305. The SS block may provide a timing reference for the passive device 205 while the MIB block may provide configuration parameters to the passive device 205. The parameters may include periodicity of the scheduling cycle 305 (e.g., 100 milliseconds (ms) certain number of slots), as well as locations information of resources, such as location of a system information block 1 (SIB 1) and RACH occasions (e.g., start offset or periodicity, location of RACH occasion, etc.). In some examples, a sub-synchronization block may also be sent in the scheduling cycle 305.

After the synchronization, the scheduling cycle 305 may include a second control message 310-b (e.g., SIB), such as in a second slot or TTI of the scheduling cycle. The SIB 1 may include tracking information, reader device ID, and other information that allows the reader device 210 to perform cell selection. Cells may include devices controlled by the reader device 210. In some examples, a SIB 1 may be transmitted in every N scheduling cycle 305, where N is greater than 1 (e.g., N≥1).

The first control message 310-a, the second control message 310-b, or both, may indicate respective sets/subsets of resources associated with the scheduling cycle 305 that may be used for different types of communications, including a first set of resources 320, a second set of resources 325, and a third set of resources 330.

The first set of resources 320 may include one or more slots/TTIs for performing RACH procedures between the respective devices. For example, the first set of resources 320 may include one or more RACH occasions. The RACH occasions may include an area in time and frequency domain that is available for the reception of a RACH preamble. The RACH facilitates the reader device 210 to schedule uplink synchronization. In some examples, such as in cases to facilitate transmission of a large quantity of data, the passive device 205 may need to communicate or schedule slots (e.g., resources) for RACH. The location of the RACH occasions may be provided in the first control message 310-a (e.g., MIB) and/or the second control message 310-b (e.g., SIB). Often, the network node 105 may determine the frequency (e.g., how often) RACH occasions may be available. For example, the network node 105 may dedicate one slot per scheduling cycle 305 to RACH occasions.

The second set of resources 325 may include one or more slots/TTIs that are dedicated to SRs, for example, for scheduling uplink and downlink transmissions. The data transmission in uplink and downlink transmissions may occupy one or more slots and the slot length may be determined and signaled by the reader device 210.

The third set of resources 330 may include one or more slots may be usable for communicating transmitting TBs of data between the respective devices. The data TBs may have variable length and occupy multiple slots/TTIs. As illustrated, the frame structure for the data transmission for one transport block may begin with control information TTI 335 (e.g., a control message) in a first slot of the data TB for both uplink and downlink transmissions. The network node 105 may transmit the control message TTI 335, which may indicate the direction of transmission, such as uplink transmission or downlink transmission. The control info TTI 335 may also include the type of cast, for example, broadcast, groupcast, or unicast, and the cast type may be identified through different types of unique IDs. In some examples, the control info TTI 335 may indicate the parameters of the transmission, such as but not limited to length, modulation coding scheme (MCS), or repetition levels. The control info TTI 335 may include the type of control message, such as SI, Msg1/2/3/4, MAC CE, PDSCH/PUSCH, CCCH/DCCH, and the like.

In a downlink transmissions scheduling, the reader device 210 may schedule when data may be transmitted in the scheduling cycle 305. The passive device 205 does not actively monitor or request from the reader a schedule of the downlink transmissions. The passive device 205 is activated to receive data when receiving the passive device 210 receives the continuous wave signal from the reader device 210 (e.g., receives a continuous wave signal including the control message(s) 310 which indicate the communication frame structure 300/scheduling cycle 305). When scheduling uplink transmissions, the passive device 210 may use the RACH to determine scheduling. In some examples, SRs may be used for scheduling uplink transmissions, for example, when the passive device 205 has low mobility and expected uplink data (e.g., expected quantity). In such examples, the passive device 205 may be use a dedicated SR message or sequence, which may be backscattered back to the reader device 210 in an SR occasion. The dedicated SR message or sequence may uniquely identify the passive device 205 and its presences, and indicate to the reader device 210 that the passive device 205 is ready to send uplink data, as well as indicate the quantity of uplink data it is ready to send.

In some examples, the uplink scheduling may use a configured grant. In a configured grant, the network node 105 may schedule the uplink data transmission in a variable number of slots for each occasion. To facilitate improved resource utilization and efficiency, the configured grant occasion may be shared by multiple passive devices 205. In this case, each passive device 205 may be assigned a dedicated sequence, which may be used to scramble data transmission from a passive device 205. The sequence may be sent by or known to the network node 105. In this manner, the network node 105 may identify the transmitter (e.g., passive device 205) of received the uplink data upon descrambling.

Following the control information TTI 335, data for the uplink transmission or the downlink transmission in data TTIs 340 may be transmitted using one or more slots. The last slot of the frame structure may include a feedback TTI 345 to provide a feedback of the received data. For example, the feedback may include an ACK, NACK, as well as request or an indication to send a retransmission of data (ARQ) (e.g., ARQ N/ACK). The reader device 210 may transmit continuous wave signals in each non-empty slot to provide energy to power the passive device 205 and/or other passive devices 205. As such, using the channel structure and the frame structure, configuration or data may be communicated between the reader device 210 and the passive device 205, additionally or alternatively to the reader device 210 transmitting the continuous wave signal to the passive device 205 and the passive device 205 responding with a passive device ID.

FIG. 4 illustrates an example of a process flow 400 that supports techniques for a passive discovery process that locates passive devices using a network of reader devices in accordance with one or more aspects of the present disclosure. In some examples, aspects of the process flow 400 may implement, or be implemented by, aspects of the wireless communications system 100, the wireless communications system 200, the communication frame structure 300, or any combination thereof. In particular, the process flow 400 illustrates signaling between a querying reader device 210 and a passive device 205 that enables the locating the passive devices 205 using a network of reader devices 210, as described with reference to FIGS. 1-3, among other aspects.

In some examples, the operations illustrated in process flow 400 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

The process flow 400 may involve a passive device 405, a first reader device 410-a (e.g., previous reader device), a second reader device 410-b (e.g., current reader device), and a wireless device 415. The first reader device 410-a and the second reader device 410-b may be examples of the reader devices 210, described with respect to FIGS. 2 and 3. The passive device 405 may be an example of the passive device 205, as described with respect to FIGS. 2 and 3. In some examples, the wireless device 415 may be a core network device, such as a network node 105, or a home reader.

At 420, the passive device 405 may perform an initial attachment with the wireless device 415. The wireless device 415 may be an example of a network node 105 (e.g., network node 105-a in FIG. 2), a home reader device, or both. In some aspects, each passive device 405 within a network of reader devices 410 may be associated with a home reader device. In some cases, the home reader may be the reader device 410 that performs the initial attachment procedure with the respective passive device 405. The wireless device 415 may generally store information of the last used or current reader device 410, perform security related functions, and store messages between the reader devices 410 that may be implemented concurrently (e.g., over-the-top) via a reader device's network connection. For example, the wireless device 415 may maintain a table or other data object which maps IDs of passive device 405 to corresponding last-known reader devices 410 within the network of reader devices 410 so that the passive device 405 is individually addressable by the wireless device 415. In some examples, the current reader device 410-b may request to become the new wireless device 415, based on a preconfigured or predetermined scheme.

At 425, the wireless device 415 may identify data for the passive device 405, such as in a downlink transmission data (e.g., mobile terminated data). In some examples, the data may include a query for the passive device 405 using the passive device ID associated with the passive device 405. In particular, at 425, the wireless device 415 may reference a data table (e.g., data object 215 in FIG. 2) using the passive device ID of the passive device 405 in order to identify a reader device ID of a reader device 410 which is (or was previously) communicatively coupled to the passive device 405. For example, the wireless device 415 may reference a data object to determine that the first reader device 410-a is the “last known” reader device 410 associated with the passive device 405.

At 430, the wireless device 415 may transmit the downlink data to the previous reader device 410-a. The continuous wave signal may indicate that the wireless device 415 has data to transmit to the passive device 405. In this regard, the wireless device 415 may transmit the data to the first reader device 410-a based on identifying the first reader device 410-a as the “last known” reader device for the passive device 405. However, the passive device 405 may no longer be associated with the previous reader device 410-a. For example, the passive device 405 may be mobile and out of an association or link threshold distance from the previous reader device 410-a on order to maintain attachment.

At 435, the first reader device 410-a, the second reader device 410-b, or both, may perform a tag discovery procedure to locate the passive device 405. In some implementations, the previous reader device 410-a may try to locate the passive device 405 first, and then the wireless device 415 or the previous reader device 410-a may perform a hierarchical paging in legacy. As discussed herein, if the passive device 405 has relocated or moved, the previous reader device 410-a may forward the data to surrounding or neighboring reader devices 410, such as the second reader device 410-b, which may further forward the data to the passive device 405. Generally, the reader devices 410 in the network of reader devices 410 may continue forwarding the data and/or continuous wave signals until a reader device 410 finds the passive device 405 associated with the reader device 410. In some cases, the current reader device 410-b may update the wireless device 415 that the current reader device 410-b is now the last known reader associated with the passive device 405.

In this example, the reader devices 410 may perform the tag discovery procedure by transmitting continuous wave signals within different tracking areas and different cells, and instructing neighboring reader devices 410 to do the same, until a reader device 410 receives a backscattered response from the passive device 405. In this example, the second reader device 410-b may receive a backscattered response from the passive device, thereby locating the passive device 405 and making the second reader device the new, current-serving reader device 410. In such a case, the second reader device 410-b may inform the first reader device 410-a that the passive device 405 has been identified ant that the second reader device 410-b is now the current reader device 410.

At 440, upon identifying the second reader device 410-b as the current reader, the first reader device 410-a may transmit (e.g., forward, relay) the data may the current reader device 410-b.

At 445, the second reader device 410-b may transmit a continuous wave signal to the passive device 405 to activate the passive device. In some aspects, as described previously herein, the continuous wave signal may include a control message (e.g., control message 310-a, 310-b) that indicates a communication frame structure (e.g., scheduling cycle 305) that will be used for combinations between the respective devices. In this regard, by indicating the communication frame structure to the passive device 405, the respective devices may both be able to identify respective sets of resources that may be used for different communications, such as resources for performing a RACH procedure (e.g., first set of resources 320), resources for scheduling requests (e.g., second set of resources 325), resources for exchanging data/TBs (e.g., third set of resources 330), or any combination thereof.

At 450, the second reader device 410-b may transmit (e.g., relay, forward) the data to the passive device 405. In particular, the second reader device 410-b may transmit the data to the passive device 405 in accordance with the communication frame structure indicated at 445. For example, as shown and described in FIG. 3, the communication message(s) 310 and/or control information TTI 335 may be used to indicate resources which are used by the second reader device 410-b to transmit the data to the passive device 405.

At 455, the passive device 405 may transmit uplink data to the current reader device 410-b (e.g., mobile originated (MO) data). In some aspects, the passive device 405 may transmit uplink data in accordance with the communication frame structure indicated at 445. For example, as shown and described in FIG. 3, the communication message(s) 310 and/or control information TTI 335 may be used to indicate resources which are used by the second reader device 410-b to transmit the data to the passive device 405. For instance, the passive device 405 may transmit a SR in the second set of resources 325, and may receive a resource allocation (e.g., within the third set of resources 330) for transmitting the uplink data.

At 460, the second reader device 410-b may transmit a message to the wireless device 415 (e.g., home reader, network node 105, etc.) which indicates the second reader device 410-b as the new current serving reader. As such, the second reader device 410-b may instruct the wireless device 415 to update a table or data object which maps passive devices 405 to corresponding last-known/current serving reader devices 410.

At 465, the wireless device 415 may update the data object (e.g., data object 215) to reflect the new pairing of the passive device 405 and the second reader device 410-b. In other words, the new serving reader device 410-b may indicate, to the wireless device 415, that it is the new current reader device 410-b for the passive device 405. As such, in cases where the wireless device 415 has subsequent data to communicate to the passive device 405 (or in cases where a reader device 410 has data to communicate and therefore queries the wireless device 415), the wireless device 415 may be able to reference the updated data object and route the data to the second reader device 410-b for relay to the passive device 405. In some examples, to facilitate the tag discovery procedure, an operator may provision tracking areas for passive devices 405 (e.g., paging). The tag may perform RACH to trigger the new serving current reader device 410-b to update the wireless device 415.

Steps 420 through 465 illustrate example signaling that is used to communicate “mobile-terminated” data from the wireless device 415/reader device 410 to the passive device 405. Comparatively, example signaling that is used to communicate “mobile-originated” data from the passive device 405 to the reader devices 410, wireless device 415, and/or CN may be illustrated with reference to steps 470 through 490.

At 470, in cases where the passive device 405 initiates uplink data via a reader device 410-b that is different from a previous reader device 410-a, the passive device 405 and the new current reader device 410-b may perform a RACH procedure to establish a link between the respective devices. In other words, the passive device 405 may perform a RACH procedure to schedule the uplink transmission. The RACH procedure may result in a reader device 410 being linked to the passive device 405 (e.g., based on a signal strength parameter). In some examples, a reader device 410 may perform the operations of the wireless device 415 in 5GC. For example, as shown in FIG. 3, the passive device 405 and the reader device 410-b may exchange RACH messages as part of a RACH procedure performed within the first set of resources 320. In this regard, in some cases, the passive device 405 may receive an indication of a communication frame structure (e.g., communication frame structure 300), and may perform the RACH procedure at 470 in accordance with the indicated communication frame structure.

At 475, the second reader device 410-b may transmit a message to the wireless device 415 (e.g., home reader, network node 105, etc.) which indicates the second reader device 410-b as the new current serving reader. As such, the second reader device 410-b may instruct the wireless device 415 to update a table or data object which maps passive devices 405 to corresponding last-known/current serving reader devices 410. The second reader device 410-b may transmit the message at 475 based on establishing a new connection and/or performing the RACH procedure with the passive device 405 at 470.

At 480, the passive device 405 may transmit uplink data to the current reader device 410-b. In some aspects, the passive device 405 may transmit uplink data in accordance with the communication frame structure indicated at 445. For example, as shown and described in FIG. 3, the communication message(s) 310 and/or control information TTI 335 may be used to indicate resources which are used by the second reader device 410-b to transmit the data to the passive device 405. For instance, the passive device 405 may transmit a SR in the second set of resources 325, and may receive a resource allocation (e.g., within the third set of resources 330) for transmitting the uplink data.

At 485, in cases where the data received from the passive device 405 is intended for the wireless device 415 and/or CN, the second reader device may transmit (e.g., relay, forward) the received data to the wireless device 415. In some examples, the messages between reader devices 410 may be implemented over-the-top via the reader device's cell network connection.

At 490, in cases where the wireless device 415 includes a home reader device for the passive device 405, the wireless device 415 may transmit a message to the second reader device 410-b which indicates the second reader device 410-b as the new home reader for the passive device 405 (e.g., message indicating home reader relocation). In some examples, the wireless device 415 may transmit the message indicating the home reader relocation based on receiving a request from the second reader device 410-b to become the new home reader for the passive device, based on a preconfigured or predetermined policy, or both.

FIG. 5 illustrates an example of another process flow 500 that supports channel and frame structures for zero-power passive devices in accordance with one or more aspects of the present disclosure. In some examples, aspects of the process flow 500 may implement, or be implemented by, aspects of the wireless communications system 100, the wireless communications system 200, the communication frame structure 300, or any combination thereof. In particular, the process flow 500 illustrates signaling between a querying reader device 210 and a passive device 205 that enables locating the passive devices 205 using a network of reader devices 210, as described with reference to FIGS. 1-3, among other aspects.

In some examples, the operations illustrated in process flow 400 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

The process flow 500 may involve passive device 505, a reader device 510-a (source or previous reader device), a reader device 510-b (target or current reader device), and a wireless device 515. The reader device 510-a and the reader device 510-b may be examples of the reader device 210, described with respect to FIG. 2 and FIG. 3. The passive device 505 may be an example of the passive device 205, as described with respect to FIG. 2 and FIG. 3. In some examples, the wireless device 515 may be a core network device, such as a network node 105, or a home reader. The process flow 500 generally describes a network of reader devices 510 that may handover or pass ownership or association with the passive device 505 to form a new links between reader devices 510 and respective passive devices 505.

At 520, the passive device 505 may communicate with (e.g., receive signals from) the current reader device 510-b. In some aspects, each of the reader devices 510 may store data indicating the passive device 505 for which it is the last-known current reader device 510-b.

At 525, the passive device 505 may communicate with (e.g., receive signals from) the second reader device 510-b. The passive device 505 may be capable of receiving continuous wave signals from multiple reader devices 510. For example, the passive device 505 may receive continuous wave signals from the first reader device 510-a and the second reader device 510-b at 520 and 525, respectively.

The passive device 505 may also receive messages from the reader devices 510 within the network of reader devices, where the messages indicate respective reader identifiers corresponding to the reader devices 510. The passive device 505 may evaluate relative signal strength of each of the continuous wave signals. Based on one or more factors, for example, the signal strength of the continuous wave signals from the multiple reader devices 510, the passive device 505 may select a new reader device 510 as the target or current reader device 510-b. For example, the passive device 505 may select the reader device 510 associated with the strongest continuous wave signal.

At 530, if the current reader device 510-a is not the reader device 510 providing the strongest continuous wave signal, the passive device 505 may perform a handover decision for handing over the association of the passive device 505 from the previous reader device 510-a (e.g., relatively weaker continuous wave signal) to the target reader device 510-b (e.g., with the relatively stronger continuous wave signal).

In some examples, a handover procedure for the handover decision may be performed when the passive device 505 has a multiple protocol data unit (multi-PDU) message but is unable to complete it using the previous reader device 510-a. For example, a tag (e.g., passive device 505) may be stateless and have only small amount of data to send or receive at a particular time.

At 535, the passive device 505 may perform a RACH procedure with the new current reader device 510-b to synchronize with the passive device 505. The passive device 505 may switch its link to the new current reader device 510-b. The passive device 505 may perform the RACH procedure with the target reader device 510-b to establish a link with the new target reader device 510-b. The new current reader device 510-b may send an indication of the link between the passive device 505 and the new current reader device 510-b to the network or other reader devices 510. The RACH procedure may include a sequence of process between the current reader device 510-b and the network via the wireless device 515 in order for the current reader device 510-b to acquire uplink synchronization and obtain the reader device ID and passive device ID for the radio access communication.

As noted previously herein, the RACH procedure performed at 535 may be performed in accordance with a communication frame structure (e.g., communication frame structure 300 illustrated in FIG. 3) that is indicated to the passive device 505. For example, in some cases, the second reader device 510-b may transmit a control message (e.g., MIB, SIB) via a continuous wave signal, where the control message indicates a communication frame structure that is to be used for communications between the respective devices. In this example, the communication frame structure may include dedicated resources (e.g., second set of resources) for performing the RACH procedure at 535.

At 540, the current reader device 510-b may update the wireless device 515 indicating that the current reader device 510-b is the new reader device associated with the passive device 505. In some examples, the wireless device 515 may store the link relationship of the reader ID of the current reader device 510-b and the passive device 505. As such, the wireless device 515 may efficiently send data to the correctly linked reader device 510.

At 545, the wireless device 515 may forward the data request to the previous reader device 510-a. The forward request may include a request for data ready to be transmitted or that has been transmitted to the previous reader device 510, to be forwarded to another reader device 510. The other reader device 510 may be associated with a unique reader ID. In this manner, the data may be further transmitted to the current reader device 510-b, which is the updated reader device 510 linked to the passive device 505.

At 550, the previous reader device 510-a may transmit the remaining buffered data to the current reader device 510-b. The remaining buffered data may include data received by or temporarily held by the previous reader device 510-a. In some examples, the data may be stored by the previous reader device 510-a until the current reader device 510-b is identified.

At 555, the new current reader device 510-b may transmit the data to the passive device 505. In particular, the current reader device 510-b may use the data received from the previous reader device 510-a based on the forward request and the remaining buffered data. In some examples, the passive device 505 may be mobile or relocated. In such instances, the passive device 505 may be discovered and determined to have moved locations. The network may identify the passive device 505 in case of uplink data from the passive device 505. Passive devices 505 may have various mobility. For example, a passive device 505 may be mobile and moved within a small area (e.g., used in-home) while another passive device 505 may be more mobile and track across a country (e.g., used for asset tracking). The different mobility levels may utilize different tag discovery procedures (e.g., tag procedures). The passive devices 505 with high mobility may assist the network by sending location updates after moving above a threshold distance (e.g., “big move”).

The reader devices 510 may be organized into different tracking areas or a one or more cells, for example, to monitor with the passive devices 505 moving in and out of the tracking areas. The passive devices 505 may transmit updates to the network when crossing a boundary a of tracking areas. In some examples, the reader devices 510 may process an algorithm to determine whether a passive device 505 has performed a big move, such as by periodically or upon a triggering event, confirm location of the tracked passive device 505. In some examples, confirmation of the location may be based on the strength of a continuous wave signal. The network may allocate reader IDs to reader devices 510, for example, based on a commonality. Accordingly, the reader devices 510 within a threshold distance (e.g., commonality of a close physical proximity) may have similar or close values of the reader IDs. For example, the reader devices 510 within a single tracking area have similar or close values within a range of values. The passive devices 505 may be associated with passive device IDs, as discussed with respect to FIG. 2. The network may also configure the passive devices 505 with a threshold difference between the reader IDs of its last used reader ID of the previous reader device 510-a and the current reader ID of the current reader device 510-b.

At 560, the passive device 505 may compare reader IDs of the reader devices 510 in the tracking area. For example, one tracking area may have range of values of 1-100 and another tracking area may have a range of values of 200-300. The passive device 505 may determine a difference between ID values of two readers from which it receives continuous wave signals.

At 565, the passive device 505 may identify a location change when the difference between the IDs is above a threshold value difference. For example, when the passive device 505 determines that the difference in the two readers IDs is more than 100, the passive device 505 may consider that the movement is a “big move,” and may notify the network accordingly.

At 570, the passive device 505 may notify the wireless device 515 of the big move. The reader device 515 may maintain current tracking area and the last used reader for a passive device 505. The network may be a 5GC or a network of reader devices 510, depending on the network utilized. When the last known current reader device 510 receives uplink data for a passive device 505, the current reader device 510 performs a hierarchical search among reader devices 510 in the current tracking area. The current reader device 510 may start a passive device discovery in a passive device's last used cell, by either performing a broadcast or groupcast. If the current reader device 510 does not receive ACK feedback, the current reader device 510 may expand the discovery to a neighboring set of reader devices 510, for example, in a different tracking area and group of cells. The scope of discovery may continue to expand if an ACK feedback is not received at the current reader device 510-b. In some examples, the discovery request may continue as long as the quantity of requests is below a threshold quantity of requests. For example, the discovery may continue as long as the average total quantity of discovery requests per reader device 510 is below the threshold (e.g., average of 1000 tags per reader and 1 request per hour or 1 request every 3.6 seconds).

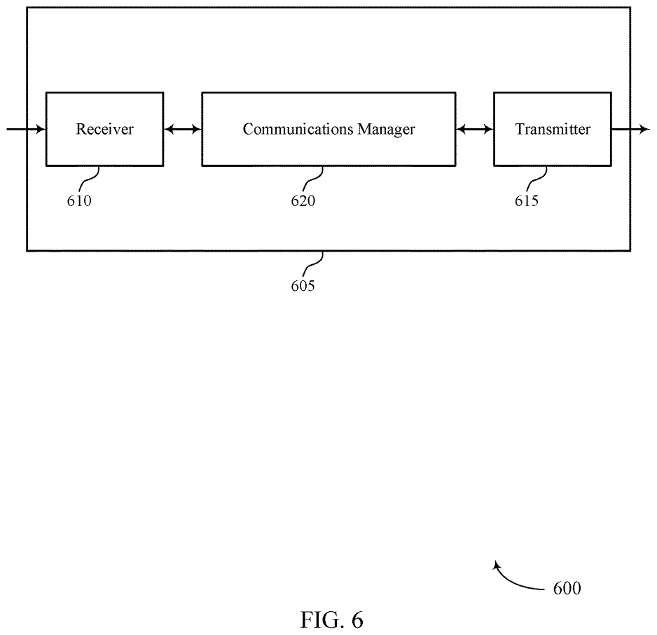

FIG. 6 illustrates a block diagram 600 of a device 605 that supports channel and frame structures for zero-power passive devices in accordance with one or more aspects of the present disclosure. The device 605 may be an example of aspects of a UE 115 as described herein. The device 605 may include a receiver 610, a transmitter 615, and a communications manager 620. The device 605 may also include one or more processors, memory coupled with the one or more processors, and instructions stored in the memory that are executable by the one or more processors to enable the one or more processors to perform the locating passive devices using a network of reader devices, as well as enabling reader devices to configure passive devices with communication frame structures that are used for wireless communication between the reader devices and the passive devices discussed herein. Each of these components may be in communication with one another (e.g., via one or more buses).

The receiver 610 may provide a means for receiving information such as packets, user data, control information, or any combination thereof associated with various information channels (e.g., control channels, data channels, information channels related to channel and frame structures for zero-power passive devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to channel and frame structures for zero-power passive devices). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of channel and frame structures for zero-power passive devices as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first reader device in accordance with examples as disclosed herein. For example, the communications manager 620 may be configured as or otherwise support a means for receiving, from a second reader device, a message including data to be communicated to a passive device, the passive device in communication with a network of reader devices including the first reader device and the second reader device, the message further indicating a first cell (and/or first tracking area) that was previously associated with the passive device during prior communications between the passive device and the second reader device. The communications manager 620 may be configured as or otherwise support a means for transmitting, within one or more additional cells (and/or additional tracking areas) different from the first cell, one or more continuous wave signals including discovery messages and an identifier associated with the passive device. The communications manager 620 may be configured as or otherwise support a means for receiving a backscattered response message from the passive device based on transmitting the one or more continuous wave signals. The communications manager 620 may be configured as or otherwise support a means for transmitting the data to the passive device based on receiving the backscattered response message.

Additionally, or alternatively, the communications manager 620 may support wireless communication at a passive device in accordance with examples as disclosed herein. For example, the communications manager 620 may be configured as or otherwise support a means for receiving a first message from a first reader device included within a network of reader devices, where the first message indicates a first reader identifier corresponding to the first reader device. The communications manager 620 may be configured as or otherwise support a means for receiving a second message from a second reader device included within the network of reader devices, where the second message indicates a second reader identifier corresponding to the second reader device. The communications manager 620 may be configured as or otherwise support a means for determining that the passive device has moved from a first tracking area associated with the first reader identifier to a second tracking area associated with the second reader identifier based on a comparison of the first reader identifier and a second reader identifier. The communications manager 620 may be configured as or otherwise support a means for transmitting, to the second reader device, a third message including an indication of the second tracking area based on determining that the passive device has moved to the second tracking area.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for identifying passive devices using a network of reader devices, as well as enabling reader devices to configure passive devices with a communication frame structures to facilitate wireless communication between the reader devices and the passive devices to provide more efficient utilization of communication resources.

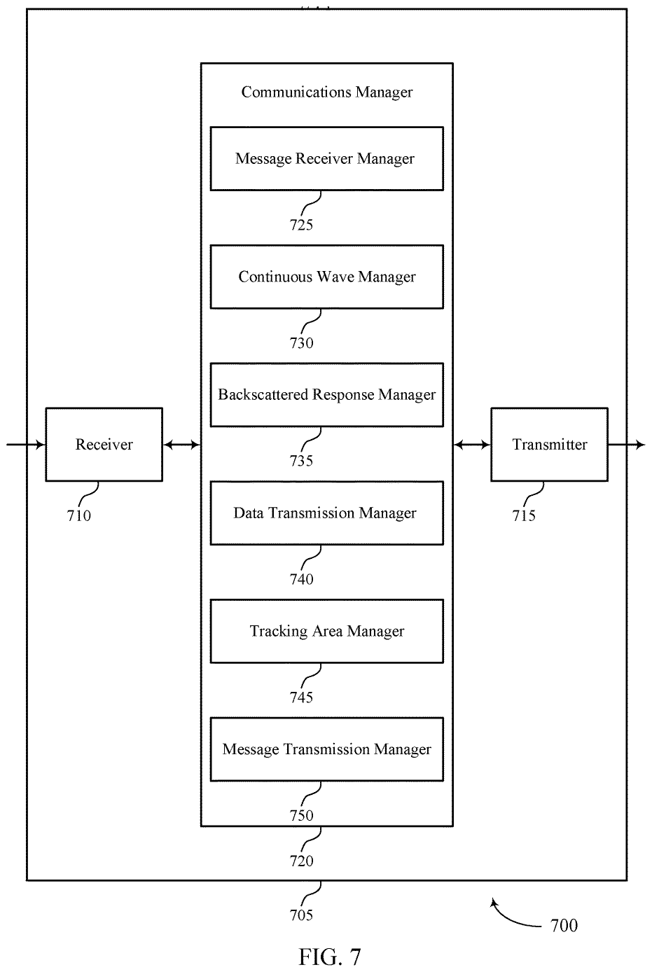

FIG. 7 illustrates a block diagram 700 of a device 705 that supports channel and frame structures for zero-power passive devices in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to channel and frame structures for zero-power passive devices). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to channel and frame structures for zero-power passive devices). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of channel and frame structures for zero-power passive devices as described herein. For example, the communications manager 720 may include a message receiver manager 725, a continuous wave manager 730, a backscattered response manager 735, a data transmission manager 740, a tracking area manager 745, a message transmission manager 750, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first reader device in accordance with examples as disclosed herein. The message receiver manager 725 may be configured as or otherwise support a means for receiving, from a second reader device, a message including data to be communicated to a passive device, the passive device in communication with a network of reader devices including the first reader device and the second reader device, the message further indicating a first cell that was previously associated with the passive device during prior communications between the passive device and the second reader device. The continuous wave manager 730 may be configured as or otherwise support a means for transmitting, within one or more additional cells different from the first cell, one or more continuous wave signals including discovery messages and an identifier associated with the passive device. The backscattered response manager 735 may be configured as or otherwise support a means for receiving a backscattered response message from the passive device based on transmitting the one or more continuous wave signals. The data transmission manager 740 may be configured as or otherwise support a means for transmitting the data to the passive device based on receiving the backscattered response message.

Additionally, or alternatively, the communications manager 720 may support wireless communication at a passive device in accordance with examples as disclosed herein. The message receiver manager 725 may be configured as or otherwise support a means for receiving a first message from a first reader device included within a network of reader devices, where the first message indicates a first reader identifier corresponding to the first reader device. The message receiver manager 725 may be configured as or otherwise support a means for receiving a second message from a second reader device included within the network of reader devices, where the second message indicates a second reader identifier corresponding to the second reader device. The tracking area manager 745 may be configured as or otherwise support a means for determining that the passive device has moved from a first tracking area associated with the first reader identifier to a second tracking area associated with the second reader identifier based on a comparison of the first reader identifier and a second reader identifier. The message transmission manager 750 may be configured as or otherwise support a means for transmitting, to the second reader device, a third message including an indication of the second tracking area based on determining that the passive device has moved to the second tracking area.

In some cases, the message receiver manager 725, the continuous wave manager 730, the backscattered response manager 735, the data transmission manager 740, the tracking area manager 745, and the message transmission manager 750, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the message receiver manager 725, the continuous wave manager 730, the backscattered response manager 735, the data transmission manager 740, the tracking area manager 745, and the message transmission manager 750, discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

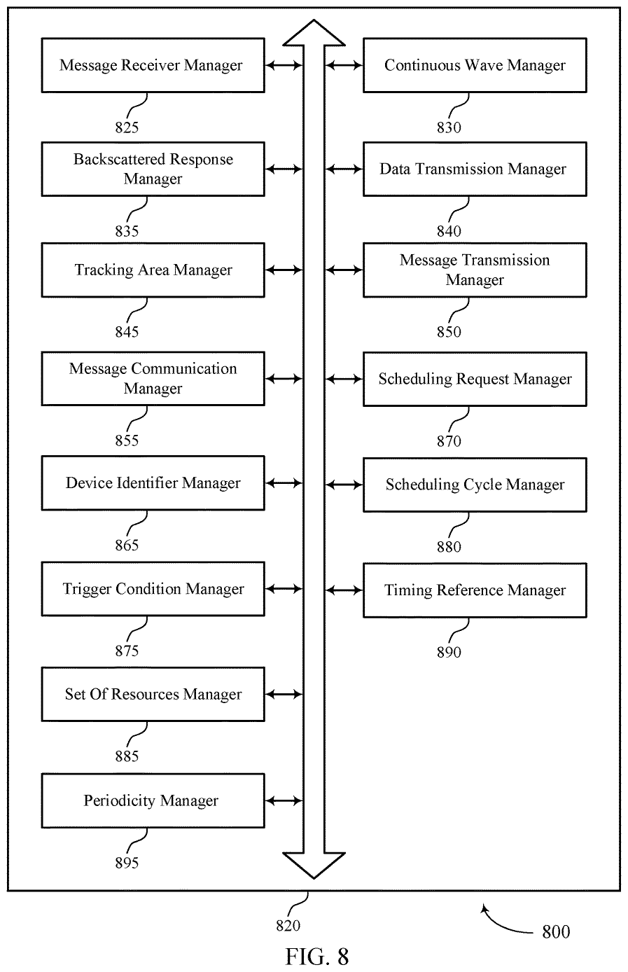

FIG. 8 illustrates a block diagram 800 of a communications manager 820 that supports channel and frame structures for zero-power passive devices in accordance with one or more aspects of the present disclosure. The communications manager 820 may be an example of aspects of a communications manager 620, a communications manager 720, or both, as described herein. The communications manager 820, or various components thereof, may be an example of means for performing various aspects of channel and frame structures for zero-power passive devices as described herein. For example, the communications manager 820 may include a message receiver manager 825, a continuous wave manager 830, a backscattered response manager 835, a data transmission manager 840, a tracking area manager 845, a message transmission manager 850, a message communication manager 855, a device identifier manager 865, a SR manager 870, a trigger condition manager 875, a scheduling cycle manager 880, a set of resources manager 885, a timing reference manager 890, a periodicity manager 895, or any combination thereof. Each of these components may communicate, directly or indirectly, with one another (e.g., via one or more buses).

The communications manager 820 may support wireless communication at a first reader device in accordance with examples as disclosed herein. The message receiver manager 825 may be configured as or otherwise support a means for receiving, from a second reader device, a message including data to be communicated to a passive device, the passive device in communication with a network of reader devices including the first reader device and the second reader device, the message further indicating a first cell that was previously associated with the passive device during prior communications between the passive device and the second reader device. The continuous wave manager 830 may be configured as or otherwise support a means for transmitting, within one or more additional cells different from the first cell, one or more continuous wave signals including discovery messages and an identifier associated with the passive device. The backscattered response manager 835 may be configured as or otherwise support a means for receiving a backscattered response message from the passive device based on transmitting the one or more continuous wave signals. The data transmission manager 840 may be configured as or otherwise support a means for transmitting the data to the passive device based on receiving the backscattered response message.

In some examples, the message transmission manager 850 may be configured as or otherwise support a means for transmitting, to a network node based on transmitting the data to the passive device, a message indicating the first reader device as a current serving reader device associated with the passive device.

In some examples, the tracking area manager 845 may be configured as or otherwise support a means for transmitting, to the network node via the message, an indication of a second cell associated with the passive device, the second cell included within the one or more additional cells.

In some examples, the one or more continuous wave signals are transmitted via a frequency channel, and the message transmission manager 850 may be configured as or otherwise support a means for transmitting, to the passive device via the one or more continuous wave signals and based on activating radio frequency circuitry of the passive device using the one or more continuous wave signals, a control message indicating a communication frame structure including resources usable for time-domain multiplexed communications between the passive device and the first reader device via the frequency channel. In some examples, the one or more continuous wave signals are transmitted via a frequency channel, and the message communication manager 855 may be configured as or otherwise support a means for communicating one or more messages with the passive device in accordance with the communication frame structure, where at least one message of the one or more messages includes the data, where the one or more messages are modulated by the first reader device via the one or more continuous wave signals or backscattered by the passive device based on the one or more continuous wave signals.

In some examples, the device identifier manager 865 may be configured as or otherwise support a means for transmitting, via the control message, a device identifier associated with the passive device, a set of passive devices including the passive device, or both, where communicating the one or more messages in accordance with the communication frame structure is based on receiving the device identifier.

In some examples, the communication frame structure includes a set of resources usable for receiving SRs, and the SR manager 870 may be configured as or otherwise support a means for receiving a SR from the passive device via the set of resources, the SR including an indication of uplink data to be communicated from the passive device to the first reader device, where communicating the one or more messages includes receiving the one or more messages including the uplink data.

In some examples, the SR manager 870 may be configured as or otherwise support a means for transmitting, to the passive device based on the SR, scheduling information for communicating the uplink data, where the one or more messages are received in accordance with the scheduling information.

In some examples, the SR manager 870 may be configured as or otherwise support a means for transmitting, via the control message, an additional control message, or both, an indication of a SR message or sequence associated with the passive device, where the SR is backscattered via the one or more continuous wave signals in accordance with the SR message/sequence. In some examples, the SR message may include a SR sequence associated with the passive device (so that receiving devices may determine that the SR message is associated with/transmitted by the respective passive device).

In some examples, the trigger condition manager 875 may be configured as or otherwise support a means for transmitting, via the control message, an indication of one or more trigger conditions for transmitting uplink data to the first reader device, where receiving the one or more messages including the uplink data is based on data collected by one or more sensors of the passive device satisfying the one or more trigger conditions.

In some examples, the scheduling cycle manager 880 may be configured as or otherwise support a means for transmitting, via the control message, an indication of a scheduling cycle periodicity associated with the communication frame structure, where communicating the one or more messages in accordance with the communication frame structure is based on the scheduling cycle periodicity.

In some examples, the control message includes a master information block message, and the set of resources manager 885 may be configured as or otherwise support a means for transmitting, via the master information block message, an indication of a set of resources within the communication frame structure for communicating SIB messages. In some examples, the control message includes a master information block message, and the message transmission manager 850 may be configured as or otherwise support a means for transmitting a SIB message within the set of resources and based on receiving the master information block message, where the SIB message indicates one or more parameters associated with the communication frame structure, where communicating the one or more messages is based on the one or more parameters.

In some examples, the periodicity manager 895 may be configured as or otherwise support a means for transmitting, via the master information block message, an indication of a periodicity for transmitting the SIB message, where the SIB message is received in accordance with the periodicity.

In some examples, the communication frame structure includes a set of multiple sets of resources usable for a set of multiple different types of communications. In some examples, the control message indicates one or more parameters associated with the set of multiple sets of resources, the one or more parameters including a starting resource offset, an ending resource offset, a periodicity, a time interval, or any combination thereof.

In some examples, the communication frame structure includes a set of random access channel resources, and the message communication manager 855 may be configured as or otherwise support a means for communicating one or more random access messages with the passive device within the set of random access channel resources as part of a random access procedure between the passive device and the first reader device, where communicating the one or more messages in accordance with the communication frame structure is based on communicating the one or more random access messages.

In some examples, the communication frame structure includes a set of transport block resources for data communication between the passive device and the first reader device, and the message transmission manager 850 may be configured as or otherwise support a means for transmitting, via a first resource of the set of transport block resources, an additional control message indicating one or more parameters usable for communications within the set of transport block resources, the one or more parameters including a type of communication, a type of communication channel, a direction of communication, a length of communication, a modulation and coding scheme, a repetition metric, or any combination thereof, where the one or more messages are communicated within the set of transport block resources in accordance with the one or more parameters.

In some examples, the continuous wave manager 830 may be configured as or otherwise support a means for transmitting a synchronization signal message via the one or more continuous wave signals. In some examples, the timing reference manager 890 may be configured as or otherwise support a means for determining a timing reference associated with a relative timing of communications between the first reader device and the passive device based on the synchronization signal message, where transmitting the control message, communicating the one or more messages, or both, is based on the timing reference.

In some examples, the control message includes a master information block message, a SIB message, or both.

In some examples, the passive device includes a radio frequency identifier tag, a passive component of a wireless device, or both. In some examples, the first reader device includes a UE, a network node, or both.

Additionally, or alternatively, the communications manager 820 may support wireless communication at a passive device in accordance with examples as disclosed herein. In some examples, the message receiver manager 825 may be configured as or otherwise support a means for receiving a first message from a first reader device included within a network of reader devices, where the first message indicates a first reader identifier corresponding to the first reader device. In some examples, the message receiver manager 825 may be configured as or otherwise support a means for receiving a second message from a second reader device included within the network of reader devices, where the second message indicates a second reader identifier corresponding to the second reader device. The tracking area manager 845 may be configured as or otherwise support a means for determining that the passive device has moved from a first tracking area associated with the first reader identifier to a second tracking area associated with the second reader identifier based on a comparison of the first reader identifier and a second reader identifier. The message transmission manager 850 may be configured as or otherwise support a means for transmitting, to the second reader device, a third message including an indication of the second tracking area based on determining that the passive device has moved to the second tracking area.

In some examples, the communication frame structure includes a set of multiple sets of resources usable for a set of multiple different types of communications. In some examples, the control message indicates one or more parameters associated with the set of multiple sets of resources, the one or more parameters including a starting resource offset, an ending resource offset, a periodicity, a time interval, or any combination thereof.

In some examples, the control message includes a master information block message, a SIB message, or both.

In some examples, the passive device includes a radio frequency identifier tag, a passive component of a wireless device, or both. In some examples, the second reader device includes a UE, a network node, or both.

In some cases, the message receiver manager 825, the continuous wave manager 830, the backscattered response manager 835, the data transmission manager 840, the tracking area manager 845, the message transmission manager 850, the message communication manager 855, the device identifier manager 865, the scheduling request manager 870, the trigger condition manager 875, the scheduling cycle manager 880, the set of resources manager 885, the timing reference manager 890, and the periodicity manager 895, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the message receiver manager 825, the continuous wave manager 830, the backscattered response manager 835, the data transmission manager 840, the tracking area manager 845, the message transmission manager 850, the message communication manager 855, the device identifier manager 865, the scheduling request manager 870, the trigger condition manager 875, the scheduling cycle manager 880, the set of resources manager 885, the timing reference manager 890, and the periodicity manager 985, discussed herein.

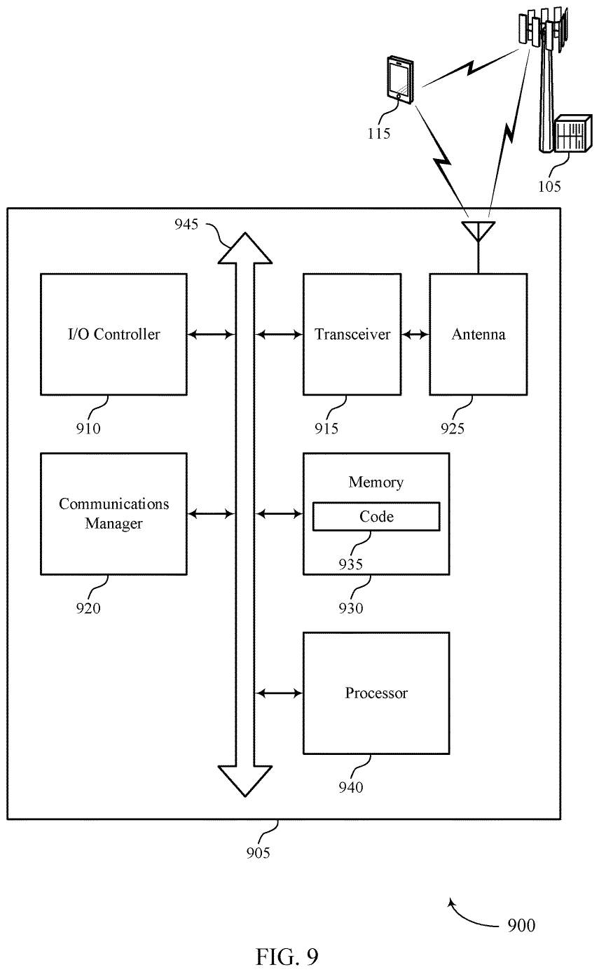

FIG. 9 illustrates a diagram of a system 900 including a device 905 that supports channel and frame structures for zero-power passive devices in accordance with one or more aspects of the present disclosure. The device 905 may be an example of or include the components of a device 605, a device 705, or a UE 115 as described herein. The device 905 may communicate (e.g., wirelessly) with one or more network nodes 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting channel and frame structures for zero-power passive devices). For example, the device 905 or a component of the device 905 may include a processor 940 and memory 930 coupled with or to the processor 940, the processor 940 and memory 930 configured to perform various functions described herein.

The communications manager 920 may support wireless communication at a first reader device in accordance with examples as disclosed herein. For example, the communications manager 920 may be configured as or otherwise support a means for receiving, from a second reader device, a message including data to be communicated to a passive device, the passive device in communication with a network of reader devices including the first reader device and the second reader device, the message further indicating a first tracking area cell that was previously associated with the passive device during prior communications between the passive device and the second reader device. The communications manager 920 may be configured as or otherwise support a means for transmitting, within one or more additional tracking area cells different from the first tracking area cell, one or more continuous wave signals including discovery messages and an identifier associated with the passive device. The communications manager 920 may be configured as or otherwise support a means for receiving a backscattered response message from the passive device based on transmitting the one or more continuous wave signals. The communications manager 920 may be configured as or otherwise support a means for transmitting the data to the passive device based on receiving the backscattered response message.

Additionally, or alternatively, the communications manager 920 may support wireless communication at a passive device in accordance with examples as disclosed herein. For example, the communications manager 920 may be configured as or otherwise support a means for receiving a first message from a first reader device included within a network of reader devices, where the first message indicates a first reader identifier corresponding to the first reader device. The communications manager 920 may be configured as or otherwise support a means for receiving a second message from a second reader device included within the network of reader devices, where the second message indicates a second reader identifier corresponding to the second reader device. The communications manager 920 may be configured as or otherwise support a means for determining that the passive device has moved from a first tracking area associated with the first reader identifier to a second tracking area associated with the second reader identifier based on a comparison of the first reader identifier and a second reader identifier. The communications manager 920 may be configured as or otherwise support a means for transmitting, to the second reader device, a third message including an indication of the second tracking area based on determining that the passive device has moved to the second tracking area.

By including or configuring the communications manager 920 in accordance with examples as described herein, the device 905 may support techniques for identifying passive devices using a network of reader devices, as well as enabling reader devices to configure passive devices with a communication frame structures to facilitate wireless communication between the reader devices and the passive devices to provide more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of channel and frame structures for zero-power passive devices as described herein, or the processor 940 and the memory 930 may be otherwise configured to perform or support such operations.

In some cases, the I/O controller 910, the transceiver 915, the communications manager 920, the antenna 925, the memory 930, and the processor 940, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the I/O controller 910, the transceiver 915, the communications manager 920, the antenna 925, the memory 930, and the processor 940, discussed herein.

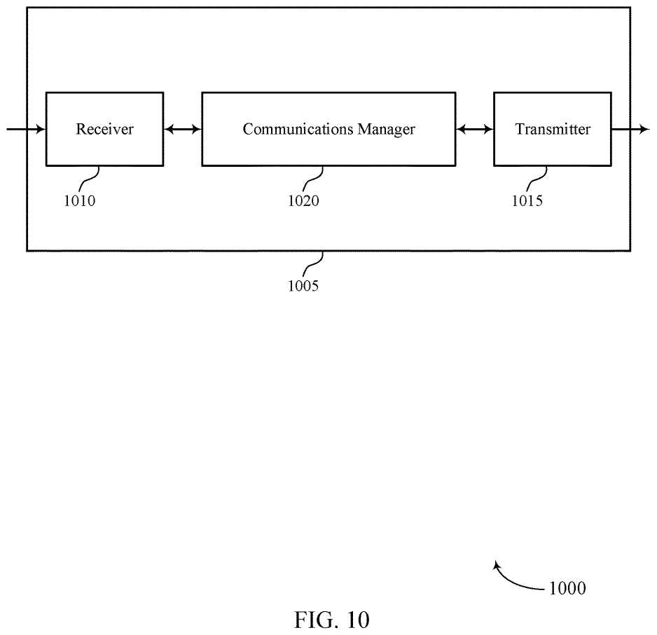

FIG. 10 illustrates a block diagram 1000 of a device 1005 that supports channel and frame structures for zero-power passive devices in accordance with one or more aspects of the present disclosure. The device 1005 may be an example of aspects of a network node 105 as described herein. The device 1005 may include a receiver 1010, a transmitter 1015, and a communications manager 1020. The device 1005 may also include one or more processors, memory coupled with the one or more processors, and instructions stored in the memory that are executable by the one or more processors to enable the one or more processors to perform the locating passive devices using a network of reader devices, as well as enabling reader devices to configure passive devices with communication frame structures that are used for wireless communication between the reader devices and the passive devices discussed herein. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of channel and frame structures for zero-power passive devices as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network node in accordance with examples as disclosed herein. For example, the communications manager 1020 may be configured as or otherwise support a means for identifying data to be communicated to a passive device that is communicatively couplable to a network of reader devices. The communications manager 1020 may be configured as or otherwise support a means for identifying a first reader device from the network of reader devices that was previously communicatively coupled with the passive device based on referencing a data object that includes mappings between a set of multiple passive devices and corresponding current reader devices from the network of reader devices. The communications manager 1020 may be configured as or otherwise support a means for transmitting the data to the first reader device along with an instruction to either relay the data to the passive device or identify a second reader device that is communicatively coupled with the passive device. The communications manager 1020 may be configured as or otherwise support a means for receiving a message indicating the first reader device or the second reader device as the current reader device corresponding to the passive device.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for identifying passive devices using a network of reader devices, as well as enabling reader devices to configure passive devices with a communication frame structures to facilitate wireless communication between the reader devices and the passive devices to provide more efficient utilization of communication resources.

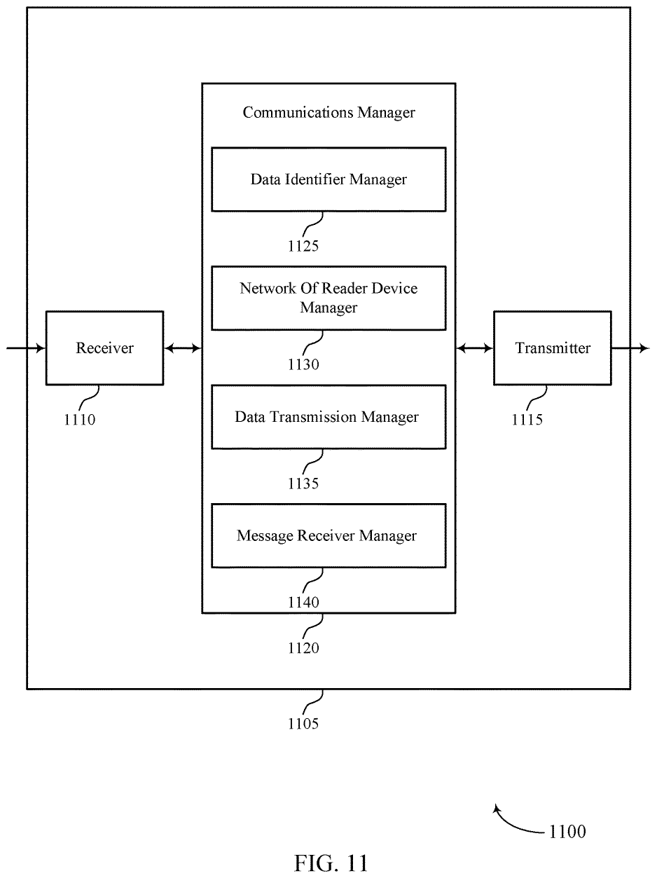

FIG. 11 illustrates a block diagram 1100 of a device 1105 that supports channel and frame structures for zero-power passive devices in accordance with one or more aspects of the present disclosure. The device 1105 may be an example of aspects of a device 1005 or a network node 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of channel and frame structures for zero-power passive devices as described herein. For example, the communications manager 1120 may include a data identifier manager 1125, a network of reader device manager 1130, a data transmission manager 1135, a message receiver manager 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network node in accordance with examples as disclosed herein. The data identifier manager 1125 may be configured as or otherwise support a means for identifying data to be communicated to a passive device that is communicatively couplable to a network of reader devices. The network of reader device manager 1130 may be configured as or otherwise support a means for identifying a first reader device from the network of reader devices that was previously communicatively coupled with the passive device based on referencing a data object that includes mappings between a set of multiple passive devices and corresponding current reader devices from the network of reader devices. The data transmission manager 1135 may be configured as or otherwise support a means for transmitting the data to the first reader device along with an instruction to either relay the data to the passive device or identify a second reader device that is communicatively coupled with the passive device. The message receiver manager 1140 may be configured as or otherwise support a means for receiving a message indicating the first reader device or the second reader device as the current reader device corresponding to the passive device.

In some cases, the data identifier manager 1125, the network of reader device manager 1130, the data transmission manager 1135, and the message receiver manager 1140 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the data identifier manager 1125, the network of reader device manager 1130, the data transmission manager 1135, and the message receiver manager 1140 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device

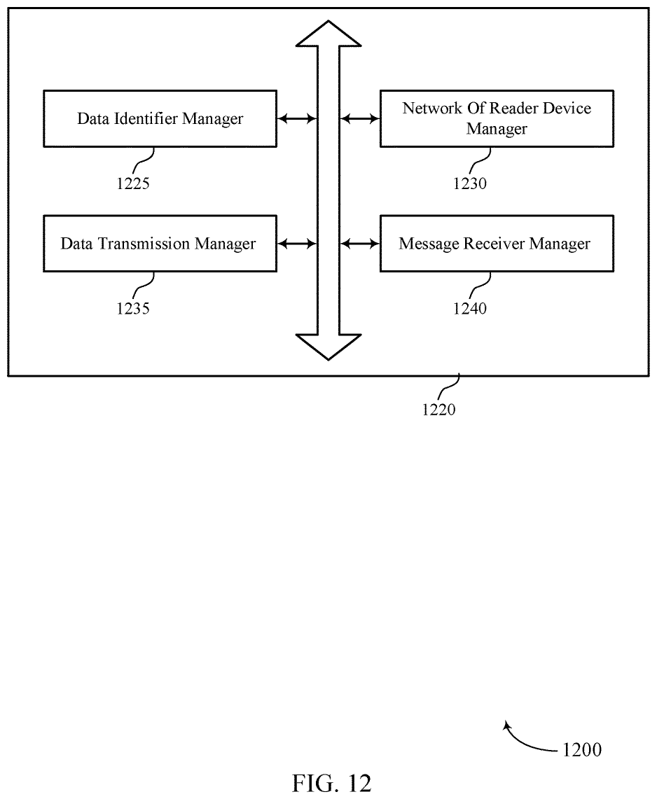

FIG. 12 illustrates a block diagram 1200 of a communications manager 1220 that supports channel and frame structures for zero-power passive devices in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of channel and frame structures for zero-power passive devices as described herein. For example, the communications manager 1220 may include a data identifier manager 1225, a network of reader device manager 1230, a data transmission manager 1235, a message receiver manager 1240, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network node 105, between devices, components, or virtualized components associated with a network node 105), or any combination thereof.

The communications manager 1220 may support wireless communication at a network node in accordance with examples as disclosed herein. The data identifier manager 1225 may be configured as or otherwise support a means for identifying data to be communicated to a passive device that is communicatively couplable to a network of reader devices. The network of reader device manager 1230 may be configured as or otherwise support a means for identifying a first reader device from the network of reader devices that was previously communicatively coupled with the passive device based on referencing a data object that includes mappings between a set of multiple passive devices and corresponding current reader devices from the network of reader devices. The data transmission manager 1235 may be configured as or otherwise support a means for transmitting the data to the first reader device along with an instruction to either relay the data to the passive device or identify a second reader device that is communicatively coupled with the passive device. The message receiver manager 1240 may be configured as or otherwise support a means for receiving a message indicating the first reader device or the second reader device as the current reader device corresponding to the passive device.

In some examples, the network node includes a base station, a home reader associated with the passive device, or both.

In some cases, the data identifier manager 1225, the network of reader device manager 1230, the data transmission manager 1235, and the message receiver manager 1240 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the data identifier manager 1225, the network of reader device manager 1230, the data transmission manager 1235, and the message receiver manager 1240 discussed herein.

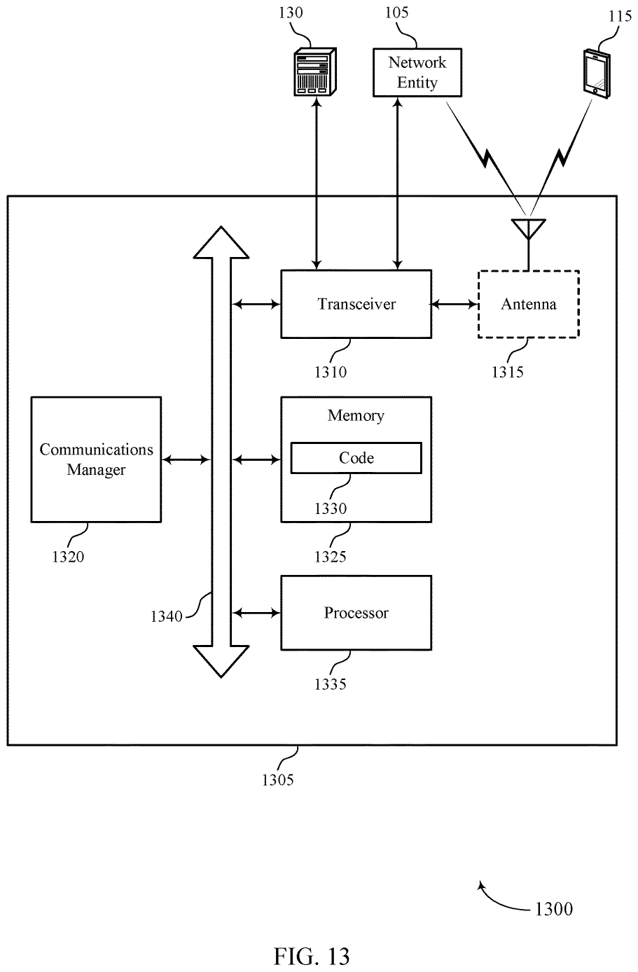

FIG. 13 illustrates a diagram of a system 1300 including a device 1305 that supports channel and frame structures for zero-power passive devices in accordance with one or more aspects of the present disclosure. The device 1305 may be an example of or include the components of a device 1005, a device 1105, or a network node 105 as described herein. The device 1305 may communicate with one or more network nodes 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting channel and frame structures for zero-power passive devices). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network nodes 105, and may include a controller or scheduler for controlling communications with UEs 115 in cooperation with other network nodes 105. In some examples, the communications manager 1320 may support an X2 interface within an LTE/LTE-A wireless communications network technology to provide communication between network nodes 105.

The communications manager 1320 may support wireless communication at a network node in accordance with examples as disclosed herein. For example, the communications manager 1320 may be configured as or otherwise support a means for identifying data to be communicated to a passive device that is communicatively couplable to a network of reader devices. The communications manager 1320 may be configured as or otherwise support a means for identifying a first reader device from the network of reader devices that was previously communicatively coupled with the passive device based on referencing a data object that includes mappings between a set of multiple passive devices and corresponding current reader devices from the network of reader devices. The communications manager 1320 may be configured as or otherwise support a means for transmitting the data to the first reader device along with an instruction to either relay the data to the passive device or identify a second reader device that is communicatively coupled with the passive device. The communications manager 1320 may be configured as or otherwise support a means for receiving a message indicating the first reader device or the second reader device as the current reader device corresponding to the passive device.

By including or configuring the communications manager 1320 in accordance with examples as described herein, the device 1305 may support techniques for identifying passive devices using a network of reader devices, as well as enabling reader devices to configure passive devices with a communication frame structures to facilitate wireless communication between the reader devices and the passive devices to provide more efficient utilization of communication resources.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of channel and frame structures for zero-power passive devices as described herein, or the processor 1335 and the memory 1325 may be otherwise configured to perform or support such operations.

In some cases, the communications manager 1320, the transceiver 1310, the antenna 1315, the memory 1325, and the processor 1335 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the communications manager 1320, the transceiver 1310, the antenna 1315, the memory 1325, and the processor 1335 discussed herein.

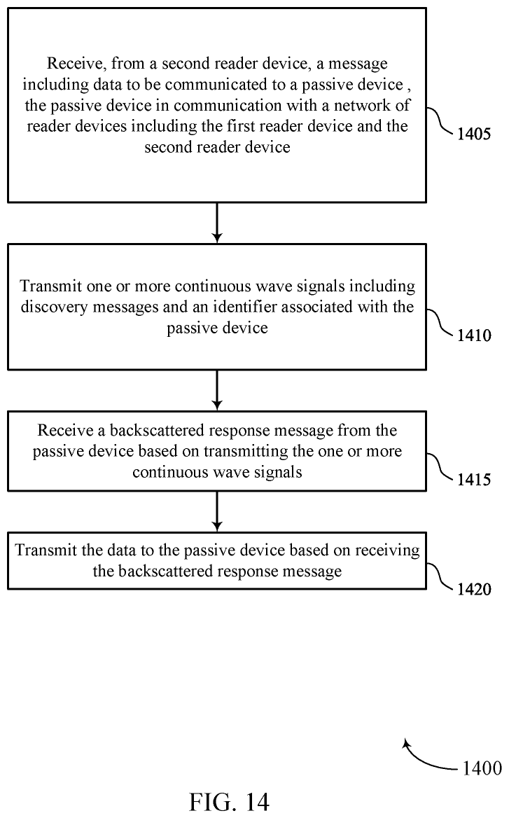

FIG. 14 illustrates a flowchart showing a method 1400 that supports channel and frame structures for zero-power passive devices in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a second reader device, a message including data to be communicated to a passive device, the passive device in communication with a network of reader devices including the first reader device and the second reader device. The operations of 1405 may be performed in accordance with examples as disclosed herein. In some examples, aspects of the operations of 1405 may be performed by a message receiver manager 825 as described with reference to FIG. 8.

At 1410, the method may include transmitting one or more continuous wave signals including discovery messages and an identifier associated with the passive device. The operations of 1410 may be performed in accordance with examples as disclosed herein. In some examples, aspects of the operations of 1410 may be performed by a continuous wave manager 830 as described with reference to FIG. 8.

At 1415, the method may include receiving a backscattered response message from the passive device based on transmitting the one or more continuous wave signals. The operations of 1415 may be performed in accordance with examples as disclosed herein. In some examples, aspects of the operations of 1415 may be performed by a backscattered response manager 835 as described with reference to FIG. 8.

At 1420, the method may include transmitting the data to the passive device based on receiving the backscattered response message. The operations of 1420 may be performed in accordance with examples as disclosed herein. In some examples, aspects of the operations of 1420 may be performed by a data transmission manager 840 as described with reference to FIG. 8.

The following provides an overview of aspects of the present disclosure:

Aspect 1: A method for wireless communication at a first reader device, comprising: receiving, from a second reader device, a message comprising data to be communicated to a passive device, the passive device in communication with a network of reader devices including the first reader device and the second reader device; transmitting one or more continuous wave signals comprising discovery messages and an identifier associated with the passive device; receiving a backscattered response message from the passive device based at least in part on transmitting the one or more continuous wave signals; and transmitting the data to the passive device based at least in part on receiving the backscattered response message.

Aspect 2: The method of aspect 1, further comprising: transmitting, to a network entity based at least in part on transmitting the data to the passive device, a message indicating the first reader device as a current serving reader device associated with the passive device.

Aspect 3: The method of any of aspects 1 through 2, wherein the message further indicates a first cell that was previously associated with the passive device during prior communications between the passive device and the second reader device.

Aspect 4: The apparatus of aspect 3, wherein the one or more continuous wave signals are transmitted within one or more additional cells different from the first cell.

Aspect 5: The method of any of aspects 1 through 4, wherein the one or more continuous wave signals are transmitted via a frequency channel, the method further comprising: transmitting, to the passive device via the one or more continuous wave signals and based at least in part on activating radio frequency circuitry of the passive device using the one or more continuous wave signals, a control message indicating a communication frame structure comprising resources usable for time-domain multiplexed communications between the passive device and the first reader device via the frequency channel; and communicating one or more messages with the passive device in accordance with the communication frame structure, wherein at least one message of the one or more messages comprises the data, wherein the one or more messages are modulated by the first reader device via the one or more continuous wave signals or backscattered by the passive device based at least in part on the one or more continuous wave signals.

Aspect 6: The method of aspect 5, further comprising: transmitting, via the control message, a device identifier associated with the passive device, a set of passive devices including the passive device, or both, wherein communicating the one or more messages in accordance with the communication frame structure is based at least in part on receiving the device identifier.

Aspect 7: The method of any of aspects 5 through 6, wherein the communication frame structure comprises a set of resources usable for receiving scheduling requests, the method further comprising: receiving a scheduling request from the passive device via the set of resources, the scheduling request comprising an indication of uplink data to be communicated from the passive device to the first reader device, wherein communicating the one or more messages comprises receiving the one or more messages including the uplink data.

Aspect 8: The method of aspect 7, further comprising: transmitting, to the passive device based at least in part on the scheduling request, scheduling information for communicating the uplink data, wherein the one or more messages are received in accordance with the scheduling information.

Aspect 9: The method of any of aspects 7 through 8, further comprising: transmitting, via the control message, an additional control message, or both, an indication of a scheduling request message indicating a quantity of uplink data to be transmitted by the passive device.

Aspect 10: The method of any of aspects 5 through 9, further comprising: transmitting, via the control message, an indication of one or more trigger conditions for transmitting uplink data to the first reader device, wherein receiving the one or more messages comprising the uplink data is based at least in part on data collected by one or more sensors of the passive device satisfying the one or more trigger conditions.

Aspect 11: The method of any of aspects 5 through 10, further comprising: transmitting, via the control message, an indication of a scheduling cycle periodicity associated with the communication frame structure, wherein communicating the one or more messages in accordance with the communication frame structure is based at least in part on the scheduling cycle periodicity.

Aspect 12: The method of any of aspects 5 through 11, wherein the control message comprises a MIB message, the method further comprising: transmitting, via the MIB message, an indication of a set of resources within the communication frame structure for communicating SIB messages; and transmitting a SIB message within the set of resources and based at least in part on receiving the MIB message, wherein the SIB message indicates one or more parameters associated with the communication frame structure, wherein communicating the one or more messages is based at least in part on the one or more parameters.

Aspect 13: The method of aspect 12, further comprising: transmitting, via the MIB message, an indication of a periodicity for transmitting the SIB message, wherein the SIB message is received in accordance with the periodicity.

Aspect 14: The method of any of aspects 5 through 13, wherein the communication frame structure comprises a plurality of sets of resources usable for a plurality of different types of communications, and the control message indicates one or more parameters associated with the plurality of sets of resources, the one or more parameters comprising a starting resource offset, an ending resource offset, a periodicity, a time interval, or any combination thereof.

Aspect 15: The method of any of aspects 5 through 14, wherein the communication frame structure comprises a set of RACH resources, the method further comprising: communicating one or more random access messages with the passive device within the set of RACH resources as part of a random access procedure between the passive device and the first reader device, wherein communicating the one or more messages in accordance with the communication frame structure is based at least in part on communicating the one or more random access messages.

Aspect 16: The method of any of aspects 5 through 15, wherein the communication frame structure comprises a set of transport block resources for data communication between the passive device and the first reader device, the method further comprising: transmitting, via a first resource of the set of transport block resources, an additional control message indicating one or more parameters usable for communications within the set of transport block resources, the one or more parameters comprising a type of communication, a type of communication channel, a direction of communication, a length of communication, a modulation and coding scheme, a repetition metric, or any combination thereof, wherein the one or more messages are communicated within the set of transport block resources in accordance with the one or more parameters.

Aspect 17: The method of any of aspects 5 through 16, further comprising: transmitting a synchronization signal message via the one or more continuous wave signals; and determining a timing reference associated with a relative timing of communications between the first reader device and the passive device based at least in part on the synchronization signal message, wherein transmitting the control message, communicating the one or more messages, or both, is based at least in part on the timing reference.

Aspect 18: The method of any of aspects 5 through 17, wherein the control message comprises a MIB message, a SIB message, or both.

Aspect 19: The method of any of aspects 1 through 18, wherein the passive device comprises a radio frequency identifier tag, a passive component of a wireless device, or both, and the first reader device comprises a UE, a network entity, or both.

Aspect 20: A method for wireless communication at a passive device, comprising: receiving a first message from a first reader device included within a network of reader devices, wherein the first message indicates a first reader identifier corresponding to the first reader device; receiving a second message from a second reader device included within the network of reader devices, wherein the second message indicates a second reader identifier corresponding to the second reader device; determining that the passive device has moved from a first tracking area associated with the first reader identifier to a second tracking area associated with the second reader identifier based at least in part on a comparison of the first reader identifier and a second reader identifier; and transmitting, to the second reader device, a third message comprising an identifier associated with the passive device based at least in part on determining that the passive device has moved to the second tracking area.

Aspect 21: The method of aspect 20, further comprising: determining a first set of parameters associated with the first message received from the first reader device, and a second set of parameters associated with the second message received from the second reader device; determining to perform a handover procedure from the first reader device to the second reader device based at least in part on a comparison of the first set of parameters and the second set of parameters; and perform a random access procedure with the second reader device based at least in part on determining to perform the handover procedure from the first reader device to the second reader device.

Aspect 22: The method of any of aspects 20 through 21, further comprising: determining a difference between the first reader identifier and the second reader identifier, wherein determining that the passive device has moved from the first tracking area associated with the first reader identifier to the second tracking area is based at least in part on the difference satisfying a threshold difference.

Aspect 23: The method of any of aspects 20 through 22, further comprising: receiving a continuous wave signal from the second reader device via a frequency channel; receiving, from the second reader device via the continuous wave signal and based at least in part on activating radio frequency circuitry of the passive device in response to the continuous wave signal, a control message indicating a communication frame structure comprising resources usable for time-domain multiplexed communications between the passive device and the second reader device via the frequency channel; and communicating one or more messages with the second reader device in accordance with the communication frame structure, the one or more messages comprising the second message, wherein the one or more messages are modulated by the second reader device via the continuous wave signal, backscattered by the passive device based at least in part on the continuous wave signal, or both.

Aspect 24: The method of aspect 23, further comprising: receiving, via the control message, a device identifier associated with the passive device, a set of passive devices including the passive device, or both, wherein communicating the one or more messages in accordance with the communication frame structure is based at least in part on receiving the device identifier.

Aspect 25: The method of any of aspects 23 through 24, wherein the communication frame structure comprises a set of resources usable for transmitting scheduling requests, the method further comprising: transmitting a scheduling request to the second reader device via the set of resources, the scheduling request comprising an indication of uplink data to be communicated from the passive device to the second reader device, wherein communicating the one or more messages comprise transmitting the one or more messages including the uplink data.

Aspect 26: The method of aspect 25, further comprising: receiving, from the second reader device based at least in part on the scheduling request, scheduling information for communicating the uplink data, wherein the one or more messages are transmitted in accordance with the scheduling information.

Aspect 27: The method of any of aspects 25 through 26, further comprising: receiving, via the control message, an additional control message, or both, an indication of a scheduling request sequence associated with the passive device, wherein transmitting the scheduling request comprises backscattering the continuous wave signal in accordance with the scheduling request sequence.

Aspect 28: The method of any of aspects 23 through 27, further comprising: receiving, via the control message, an indication of one or more trigger conditions for transmitting uplink data to the second reader device; collecting data using one or more sensors associated with the passive device; and transmitting the one or more messages comprising the uplink data to the second reader device based at least in part on the data satisfying the one or more trigger conditions.

Aspect 29: The method of any of aspects 23 through 28, further comprising: receiving, via the control message, an indication of a scheduling cycle periodicity associated with the communication frame structure, wherein communicating the one or more messages in accordance with the communication frame structure is based at least in part on the scheduling cycle periodicity.

Aspect 30: The method of any of aspects 23 through 29, wherein the control message comprises a MIB message, the method further comprising: receiving, via the MIB message, an indication of a set of resources within the communication frame structure for communicating SIB messages; and receiving a SIB message within the set of resources and based at least in part on receiving the MIB message, wherein the SIB message indicates one or more parameters associated with the communication frame structure, wherein communicating the one or more messages is based at least in part on the one or more parameters.

Aspect 31: The method of aspect 30, further comprising: receiving, via the MIB message, an indication of a periodicity for receiving the SIB message, wherein the SIB message is received in accordance with the periodicity.

Aspect 32: The method of any of aspects 23 through 31, wherein the communication frame structure comprises a plurality of sets of resources usable for a plurality of different types of communications, and the control message indicates one or more parameters associated with the plurality of sets of resources, the one or more parameters comprising a starting resource offset, an ending resource offset, a periodicity, a time interval, or any combination thereof.

Aspect 33: The method of any of aspects 23 through 32, wherein the communication frame structure comprises a set of RACH resources, the method further comprising: communicating one or more random access messages with the second reader device within the set of RACH resources as part of a random access procedure between the passive device and the second reader device, wherein communicating the one or more messages in accordance with the communication frame structure is based at least in part on communicating the one or more random access messages.

Aspect 34: The method of any of aspects 23 through 33, wherein the communication frame structure comprises a set of transport block resources for data communication between the passive device and the second reader device, the method further comprising: receiving, via a first resource of the set of transport block resources, an additional control message indicating one or more parameters usable for communications within the set of transport block resources, the one or more parameters comprising a type of communication, a type of communication channel, a direction of communication, a length of communication, a modulation and coding scheme, a repetition metric, or any combination thereof, wherein the one or more messages are communicated within the set of transport block resources in accordance with the one or more parameters.

Aspect 35: The method of any of aspects 23 through 34, further comprising: receiving a synchronization signal message via the continuous wave signal; and determining a timing reference associated with a relative timing of communications between the second reader device and the passive device based at least in part on the synchronization signal message, wherein receiving the control message, communicating the one or more messages, or both, is based at least in part on the timing reference.

Aspect 36: The method of any of aspects 23 through 35, wherein the control message comprises a MIB message, a SIB message, or both.

Aspect 37: The method of any of aspects 20 through 36, wherein the passive device comprises a radio frequency identifier tag, a passive component of a wireless device, or both, and the second reader device comprises a UE, a network entity, or both.

Aspect 38: A method for wireless communication at a wireless device, comprising: identifying data to be communicated to a passive device that is communicatively couplable to a network of reader devices; identifying a first reader device from the network of reader devices that was previously communicatively coupled with the passive device based at least in part on referencing a data object that comprises mappings between a plurality of passive devices and corresponding current reader devices from the network of reader devices; transmitting the data to the first reader device along with an instruction to either relay the data to the passive device or identify a second reader device that is communicatively coupled with the passive device; and receiving a message indicating the first reader device or the second reader device as the current reader device corresponding to the passive device.

Aspect 39: The method of aspect 38, further comprising: updating the data object based at least in part on receiving the message.

Aspect 40: The method of any of aspects 38 through 39, wherein the network entity comprises a base station, a home reader associated with the passive device, or both.

Aspect 41: An apparatus for wireless communication at a first reader device, comprising a processor; memory coupled with the processor; and instructions stored in the memory and executable by the processor to cause the apparatus to perform a method of any of aspects 1 through 19.

Aspect 42: An apparatus for wireless communication at a first reader device, comprising at least one means for performing a method of any of aspects 1 through 19.

Aspect 43: A non-transitory computer-readable medium storing code for wireless communication at a first reader device, the code comprising instructions executable by a processor to perform a method of any of aspects 1 through 19.

Aspect 44: An apparatus for wireless communication at a passive device, comprising a processor; memory coupled with the processor; and instructions stored in the memory and executable by the processor to cause the apparatus to perform a method of any of aspects 20 through 37.

Aspect 45: An apparatus for wireless communication at a passive device, comprising at least one means for performing a method of any of aspects 20 through 37.

Aspect 46: A non-transitory computer-readable medium storing code for wireless communication at a passive device, the code comprising instructions executable by a processor to perform a method of any of aspects 20 through 37.

Aspect 47: An apparatus for wireless communication at a wireless device, comprising a processor; memory coupled with the processor; and instructions stored in the memory and executable by the processor to cause the apparatus to perform a method of any of aspects 38 through 40.

Aspect 48: An apparatus for wireless communication at a wireless device, comprising at least one means for performing a method of any of aspects 38 through 40.

Aspect 49: A non-transitory computer-readable medium storing code for wireless communication at a wireless device, the code comprising instructions executable by a processor to perform a method of any of aspects 38 through 40.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a first reader device, comprising:
a processor;
memory coupled with the processor; and
instructions stored in the memory and executable by the processor to cause the apparatus to:
receive, from a second reader device, a message comprising data to be communicated to a passive device, the passive device in communication with a network of reader devices including the first reader device and the second reader device;
transmit one or more continuous wave signals comprising discovery messages and an identifier associated with the passive device;
receive a backscattered response message from the passive device based at least in part on transmitting the one or more continuous wave signals; and
transmit the data to the passive device based at least in part on receiving the backscattered response message.

2. The apparatus of claim 1, wherein the instructions are further executable by the processor to cause the apparatus to:
transmit, to a network node based at least in part on transmitting the data to the passive device, a message indicating the first reader device as a current serving reader device associated with the passive device.

3. The apparatus of claim 1, wherein the message further indicates a first cell that was previously associated with the passive device during prior communications between the passive device and the second reader device.

4. The apparatus of claim 3, wherein the one or more continuous wave signals are transmitted within one or more additional cells different from the first cell.

5. The apparatus of claim 4, wherein the instructions are further executable by the processor to cause the apparatus to:
transmit, to the network node via the message, an indication of a second cell associated with the passive device, the second cell included within the one or more additional cells.

6. The apparatus of claim 1, wherein the one or more continuous wave signals are transmitted via a frequency channel, and the instructions are further executable by the processor to cause the apparatus to:
transmit, to the passive device via the one or more continuous wave signals and based at least in part on activating radio frequency circuitry of the passive device using the one or more continuous wave signals, a control message indicating a communication frame structure comprising resources usable for time-domain multiplexed communications between the passive device and the first reader device via the frequency channel; and
communicate one or more messages with the passive device in accordance with the communication frame structure, wherein at least one message of the one or more messages comprises the data, wherein the one or more messages are modulated by the first reader device via the one or more continuous wave signals or backscattered by the passive device based at least in part on the one or more continuous wave signals.

7. The apparatus of claim 6, wherein the instructions are further executable by the processor to cause the apparatus to:
transmit, via the control message, a device identifier associated with the passive device, a set of passive devices including the passive device, or both, wherein communicating the one or more messages in accordance with the communication frame structure is based at least in part on receiving the device identifier.

8. The apparatus of claim 6, wherein the communication frame structure comprises a set of resources usable for receiving scheduling requests, and the instructions are further executable by the processor to cause the apparatus to:
receive a scheduling request from the passive device via the set of resources, the scheduling request comprising an indication of uplink data to be communicated from the passive device to the first reader device, wherein communicating the one or more messages comprises receiving the one or more messages including the uplink data.

9. The apparatus of claim 8, wherein the instructions are further executable by the processor to cause the apparatus to:
transmit, to the passive device based at least in part on the scheduling request, scheduling information for communicating the uplink data, wherein the one or more messages are received in accordance with the scheduling information.

10. The apparatus of claim 8, wherein the instructions are further executable by the processor to cause the apparatus to:
transmit, via the control message, an additional control message, or both, an indication of a scheduling request message indicating a quantity of uplink data to be transmitted by the passive device.

11. The apparatus of claim 6, wherein the instructions are further executable by the processor to cause the apparatus to:
transmit, via the control message, an indication of one or more trigger conditions for transmitting uplink data to the first reader device, wherein receiving the one or more messages comprising the uplink data is based at least in part on data collected by one or more sensors of the passive device satisfying the one or more trigger conditions.

12. The apparatus of claim 6, wherein the instructions are further executable by the processor to cause the apparatus to:
transmit, via the control message, an indication of a scheduling cycle periodicity associated with the communication frame structure, wherein communicating the one or more messages in accordance with the communication frame structure is based at least in part on the scheduling cycle periodicity.

13. The apparatus of claim 6, wherein the control message comprises a master information block message, and the instructions are further executable by the processor to cause the apparatus to:
transmit, via the master information block message, an indication of a set of resources within the communication frame structure for communicating system information block messages; and
transmit a system information block message within the set of resources and based at least in part on receiving the master information block message, wherein the system information block message indicates one or more parameters associated with the communication frame structure, wherein communicating the one or more messages is based at least in part on the one or more parameters.

14. The apparatus of claim 13, wherein the instructions are further executable by the processor to cause the apparatus to:
transmit, via the master information block message, an indication of a periodicity for transmitting the system information block message wherein the system information block message is received in accordance with the periodicity.

15. The apparatus of claim 6, wherein the communication frame structure comprises a plurality of sets of resources usable for a plurality of different types of communications, and wherein the control message indicates one or more parameters associated with the plurality of sets of resources, the one or more parameters comprising a starting resource offset, an ending resource offset, a periodicity, a time interval, or any combination thereof.

16. The apparatus of claim 6, wherein the communication frame structure comprises a set of random access channel resources, and the instructions are further executable by the processor to cause the apparatus to:
communicate one or more random access messages with the passive device within the set of random access channel resources as part of a random access procedure between the passive device and the first reader device, wherein communicating the one or more messages in accordance with the communication frame structure is based at least in part on communicating the one or more random access messages.

17. The apparatus of claim 6, wherein the communication frame structure comprises a set of transport block resources for data communication between the passive device and the first reader device, and the instructions are further executable by the processor to cause the apparatus to:
transmit, via a first resource of the set of transport block resources, an additional control message indicating one or more parameters usable for communications within the set of transport block resources, the one or more parameters comprising a type of communication, a type of communication channel, a direction of communication, a length of communication, a modulation and coding scheme, a repetition metric, or any combination thereof, wherein the one or more messages are communicated within the set of transport block resources in accordance with the one or more parameters.

18. The apparatus of claim 6, wherein the instructions are further executable by the processor to cause the apparatus to:
transmit a synchronization signal message via the one or more continuous wave signals; and
determine a timing reference associated with a relative timing of communications between the first reader device and the passive device based at least in part on the synchronization signal message, wherein transmitting the control message, communicating the one or more messages, or both, is based at least in part on the timing reference.

19-20. (canceled)

21. An apparatus for wireless communication at a passive device, comprising:
a processor;
memory coupled with the processor; and
instructions stored in the memory and executable by the processor to cause the apparatus to:
receive a first message from a first reader device included within a network of reader devices, wherein the first message indicates a first reader identifier corresponding to the first reader device;
receive a second message from a second reader device included within the network of reader devices, wherein the second message indicates a second reader identifier corresponding to the second reader device;
determine that the passive device has moved from a first tracking area associated with the first reader identifier to a second tracking area associated with the second reader identifier based at least in part on a comparison of the first reader identifier and a second reader identifier; and
transmit, to the second reader device, a third message comprising an identifier associated with the passive device based at least in part on determining that the passive device has moved to the second tracking area.

22-29. (canceled)

30. An apparatus for wireless communication at a wireless device, comprising:
a processor;
memory coupled with the processor; and
instructions stored in the memory and executable by the processor to cause the apparatus to:
identify data to be communicated to a passive device that is communicatively couplable to a network of reader devices;
identify a first reader device from the network of reader devices that was previously communicatively coupled with the passive device based at least in part on referencing a data object that comprises mappings between a plurality of passive devices and corresponding current reader devices from the network of reader devices;
transmit the data to the first reader device along with an instruction to either relay the data to the passive device or identify a second reader device that is communicatively coupled with the passive device; and
receive a message indicating the first reader device or the second reader device as the current reader device corresponding to the passive device.
